(19) United States
(12) Patent Application Publication
(10) Pub. No.: US 2020/0399413 A1
(43) Pub. Date: Dec. 24, 2020

(54) VINYL-BASED RESIN PARTICLES AND METHOD FOR MANUFACTURING SAME

(71) Applicant: SEKISUI KASEI CO., LTD., Osaka (JP)

(72) Inventors: Kengo NISHIUMI, Osaka (JP); Ryosuke HARADA, Osaka (JP)

(73) Assignee: SEKISUI KASEI CO., LTD., Osaka (JP)

(21) Appl. No.: 16/978,514

(22) PCT Filed: Mar. 22, 2019
(86) PCT No.: PCT/JP2019/012089

§ 371 Date: Sep. 4, 2020

(30) Foreign Application Priority Data
Mar. 23, 2018 (JP) 2018-056114

(51) Int. Cl. C08F 257/02; C08J 3/12; C08J 9/26; C08K 5/36

(52) U.S. Cl. CPC C08F 257/02; C08J 3/12; C08J 2351/00; C08K 5/36; C08J 9/26

(57) ABSTRACT

The present invention provides vinyl-based resin particles capable of forming uniform pores in a thermosetting resin film when the particles are used as a pore-forming material for a thermosetting resin. Specifically, the present invention provides vinyl-based resin particles for use in making a thermosetting resin porous, the particles having a temperature of 300 to 350° C. at 10% mass loss when heated at a rate of 10° C./min in an air atmosphere, and the particles having a mass loss percentage of 85 to 100% after being heated at 350° C. for 5 hours in an air atmosphere.

### TECHNICAL FIELD

The present invention relates to vinyl-based resin particles and a method for producing the vinyl-based resin particles.

### BACKGROUND ART

Polyimide resins are used as a heat-resistant material or an insulating material for electronic components because of their excellent heat resistance, mechanical strength, electrical characteristics, chemical resistance, molding characteristics, and other characteristics.

Polyimide resins used as an insulating material for electronic components are required to have improved electrical characteristics while maintaining heat resistance and mechanical strength. In particular, to suppress the attenuation of high-frequency currents of electronic components, such polyimide resins are required to have a reduced dielectric constant.

For example, a known low-dielectric polyimide resin is a porous polyimide in which the dielectric constant is reduced by increasing the porosity of a polyimide resin.

Forming large pores in a porous polyimide readily increases the porosity, but on the other hand, reduces the heat resistance and mechanical strength. It is thus necessary to increase the porosity by dispersing pores that are as small as possible at high density.

For example, Patent Literature (PTL) 1 discloses a method for producing a lithium secondary battery separator, comprising applying a polyimide precursor slurry containing uniformly dispersed silica particles to at least one surface of a substrate, subjecting the slurry to a cyclodehydration reaction for polyimidization to form a 5- to 20-μm-thick silica-polyimide film containing three-dimensionally ordered silica particles, and removing the silica particles from the silica-polyimide film.

PTL 2 discloses a method for producing a porous polyimide film, comprising a firing step of firing an unfired composite film containing polyamic acid or polyimide, resin fine particles, and a condensing agent at a temperature lower than the decomposition temperature of the resin fine particles to form a polyimide-resin fine particle composite film; and a fine particle removing step of removing the resin fine particles from the polyimide-resin fine particle composite film.

### CITATION LIST

### Patent Literature

PTL 1: WO2013/084368
PTL 2: WO2014/196435

### SUMMARY OF INVENTION

### Technical Problem

PTL 1 discloses bringing the substrate on which the silica-polyimide film is formed into contact with hydrofluoric acid (HF) to remove the silica particles. However, hydrofluoric acid is difficult to handle due to its toxicity, corrosiveness, and explosion risk during reaction, and requires a special device for controlling hydrofluoric acid, as well as costly waste liquid treatment. Thus, a method for producing a porous polyimide film without using hydrofluoric acid is desired.

The Examples of PTL2 disclose that a porous polyimide film having good film strength was obtained by adding a condensing agent without using hydrofluoric acid even when heat treatment was performed at a temperature as low as 230° C. However, the formed pores of the polyimide film are distorted and have a non-uniform porous shape compared with those of the porous polyimide films of the Comparative Examples obtained by using hydrofluoric acid.

An object of the present invention is to provide vinyl-based resin particles capable of forming uniform pores in a thermosetting resin film in a simple manner and a method for producing the vinyl-based resin particles.

### Solution to Problem

As a result of extensive research to achieve the above object, the present inventors succeeded in developing vinyl-based resin particles exhibiting specific thermal decomposition behavior in an air atmosphere and found that the object can be achieved by using the vinyl-based resin particles. The inventors conducted further research and have accomplished the present invention.

Specifically, the present invention provides the invention according to the following embodiments.

### Item 1.

Vinyl-based resin particles for use in making a thermosetting resin porous,

the particles having a temperature of 300 to 350° C. at 10% mass loss when heated at a rate of 10° C./min in an air atmosphere, and

the particles having a mass loss percentage of 85 to 100% after being heated at 350° C. for 5 hours in an air atmosphere.

### Item 2.

The vinyl-based resin particles according to Item 1, which have a number average particle diameter of 0.2 to 1.5 μm.

### Item 3.

The vinyl-based resin particles according to Item 1 or 2, wherein the coefficient of variation of the number average particle diameter is 25% or less.

### Item 4.

The vinyl-based resin particles according to any one of Items 1 to 3, wherein the proportion of the number of particles having a number average particle diameter that is 2 to 10 times the median diameter (D50) on a number basis is 0 to 5%.

### Item 5.

The vinyl-based resin particles according to any one of Items 1 to 4, wherein the vinyl-based resin particles are formed of a polymer having a polymerizable vinylic monomer unit containing a monofunctional styrenic monomer unit, and the proportion of the monofunctional styrenic monomer unit in the polymerizable vinylic monomer unit is 60 to 100 mass %.

### Item 6.

The vinyl-based resin particles according to any one of Items 1 to 4, wherein the vinyl-based resin particles are formed of a polymer having a polymerizable vinylic monomer unit composed of a monofunctional monomer unit and a polyfunctional monomer unit, and the proportion of the polyfunctional monomer unit in the polymerizable vinylic monomer unit is 1 to 15 mass %.

### Item 7.

The vinyl-based resin particles according to Item 6, wherein the monofunctional monomer unit is at least one member selected from the group consisting of a monofunctional styrenic monomer unit and a monofunctional (meth)acrylic monomer unit, and the polyfunctional monomer unit is at least one member selected from the group consisting of a polyfunctional styrenic monomer unit and a polyfunctional (meth)acrylic monomer unit.

### Item 8.

The vinyl-based resin particles according to any one of Items 1 to 7, wherein a pH of 3 to 9 is obtained when the vinyl-based resin particles are dispersed in water so that the mass ratio of the vinyl-based resin particles to water is 1:10.

### Item 9.

A method for producing the vinyl-based resin particles according to Item 5, the method comprising:

an emulsion polymerization step of emulsion-polymerizing a first polymerizable vinylic monomer in an aqueous medium to obtain an aqueous dispersion containing polymer particles of the first polymerizable vinylic monomer and the aqueous medium;

a pH adjustment step of adding a nitrogen-containing compound to the aqueous dispersion obtained in the emulsion polymerization step to adjust the pH of the aqueous dispersion to 3 to 9;

a spray-drying step of spray-drying the aqueous dispersion obtained in the pH adjustment step at an inlet temperature of 80 to 220° C. and an outlet temperature of 50 to 100° C. to obtain an aggregate; and

a crushing step of crushing the aggregate obtained in the spray-drying step to obtain vinyl-based resin particles.

### Item 10.

The method for producing the vinyl-based resin particles according to Item 9, comprising at least one of a first classification step of classifying the polymer particles obtained in the emulsion polymerization step and a second classification step of classifying the vinyl-based resin particles obtained in the crushing step.

### Item 11.

A method for producing the vinyl-based resin particles according to Item 6 or 7, the method comprising:

a seed polymerization step of performing seed polymerization by absorbing a second polymerizable vinylic monomer into seed particles to obtain an aqueous dispersion containing polymer particles of the second polymerizable vinylic monomer and an aqueous medium;

a spray-drying step of spray-drying the aqueous dispersion obtained in the seed polymerization step at an inlet temperature of 80 to 220° C. and an outlet temperature of 50 to 100° C. to obtain an aggregate; and

a crushing step of crushing the aggregate obtained in the spray-drying step to obtain vinyl-based resin particles,

wherein in the seed polymerization step, the second polymerizable vinylic monomer comprise a monofunctional monomer and a polyfunctional monomer, and the second polymerizable vinylic monomer comprise the polyfunctional monomer in an amount of 1 to 15 parts by mass based on 100 parts by mass of the monofunctional monomer.

### Item 12.

The method for producing the vinyl-based resin particles according to Item 11, comprising at least one of a first classification step of classifying the polymer particles obtained in the seed polymerization step and a second classification step of classifying the vinyl-based resin particles obtained in the crushing step.

### Advantageous Effects of Invention

When the vinyl-based resin particles of the present invention are used as a pore-forming material for a thermosetting resin, uniform pores can be easily formed in a thermosetting resin film. The use of the vinyl-based resin particles of the present invention makes it possible to form uniform pores in a thermosetting resin film in a simple manner without using hydrofluoric acid, unlike conventional techniques.

### BRIEF DESCRIPTION OF DRAWINGS

FIG. 1(A) is a scanning electron microscope (SEM) photograph of an aggregate of vinyl-based resin particles obtained in Example 1. FIG. 1(B) is an SEM photograph of vinyl-based resin particles obtained by crushing the aggregate.

FIG. 2(A) is an SEM photograph of an aggregate of vinyl-based resin particles obtained in Example 2. FIG. 2(B) is an SEM photograph of vinyl-based resin particles obtained by crushing the aggregate.

FIG. 3(A) is an SEM photograph of an aggregate of vinyl-based resin particles obtained in Example 3. FIG. 3(B) is an SEM photograph of vinyl-based resin particles obtained by crushing the aggregate.

FIG. 4(A) is an SEM photograph of an aggregate of vinyl-based resin particles obtained in Example 4. FIG. 4(B) is an SEM photograph of vinyl-based resin particles obtained by crushing the aggregate.

FIG. 5(A) is an SEM photograph of an aggregate of vinyl-based resin particles obtained in Example 5. FIG. 5(B) is an SEM photograph of vinyl-based resin particles obtained by crushing the aggregate.

FIG. 6(A) is an SEM photograph of an aggregate of vinyl-based resin particles obtained in Comparative Example 1. FIG. 6(B) is an SEM photograph of vinyl-based resin particles obtained by crushing the aggregate.

FIG. 7(A) is an SEM photograph of an aggregate of vinyl-based resin particles obtained in Comparative Example 2. FIG. 7(B) is an SEM photograph of vinyl-based resin particles obtained by crushing the aggregate.

### DESCRIPTION OF EMBODIMENTS

Preferred embodiments of the present invention are described in detail below.

In the present specification, “(meth)acrylic” means acrylic or methacrylic, and “(meth)acrylate” means acrylate or methacrylate.

In the present specification, the phrase “monofunctional styrenic monomer unit” refers to a repeating structural unit formed when a monofunctional styrenic monomer is polymerized, and does not refer to the monomer itself. Similarly, the phrase “monofunctional (meth)acrylic monomer unit” refers to a repeating structural unit formed when a monofunctional (meth)acrylic monomer is polymerized, and does not refer to the monomer itself.

In the present specification, the phrase “polyfunctional styrenic monomer unit” refers to a repeating structural unit formed when a polyfunctional styrenic monomer is polymerized, and does not refer to the monomer itself. Similarly, the phrase “polyfunctional (meth)acrylic monomer unit” refers to a repeating structural unit formed when a polyfunctional (meth)acrylic monomer is polymerized, and does not refer to the monomer itself.

In the present specification, the pH of vinyl-based resin particles means the pH of a dispersion obtained by dispersing the vinyl-based resin particles in water so that the mass ratio of the vinyl-based resin particles to water is 1:10 (dispersion of the vinyl-based resin particles) measured at room temperature (20 to 25° C.) with a pH meter.

### 1. Vinyl-Based Resin Particles

The vinyl-based resin particles of the present invention have the characteristics that the particles have a temperature of 300 to 350° C. at 10% mass loss when heated at a rate of 10° C./min in an air atmosphere, and that the particles have a mass loss percentage of 85 to 100% after being heated at 350° C. for 5 hours in an air atmosphere.

Since the vinyl-based resin particles of the present invention have the above characteristics, the particles are suitably used for making a thermosetting resin porous. Specifically, the vinyl-based resin particles of the present invention, which have the above characteristics, are capable of forming uniform pores in a thermosetting resin film when used as a pore-forming material for a thermosetting resin.

### Thermal Decomposition Behavior

The temperature of the vinyl-based resin particles of the present invention at 10% mass loss (10% thermal decomposition temperature) when the particles are heated from 40° C. to 500° C. at a heating rate of 10° C./min in an air atmosphere using a thermogravimetric-differential thermal analyzer (also referred to below as a “TGA apparatus”) is 300 to 350° C., and the mass loss percentage of the particles when the particles are heated at 350° C. for 5 hours after they are heated from 40° C. to 350° C. at a heating rate of 10° C./min in an air atmosphere is 85 to 100%.

In the present specification, the 10% thermal decomposition temperature means the temperature at which the mass loss percentage of a sample is 10 mass % when the sample is heated at a heating rate of 10° C./min in an air atmosphere using a TGA apparatus. As the TGA apparatus, for example, a TG/DTA6200 (produced by SII NanoTechnology Inc.) can be used. The mass of the vinyl-based resin particles of the present invention used as the sample here is about 15 mg.

In the present specification, the mass loss percentage after heating at 350° C. for 5 hours in an air atmosphere can be calculated from the following equation: [(mass of sample before heating-mass of sample after heating)/mass of sample before heating]×100. The mass loss percentage after heating at 350° C. for 5 hours can be measured using a TGA apparatus.

If the 10% thermal decomposition temperature is higher than 350° C., the vinyl-based resin particles added for making a thermosetting resin porous cannot be decomposed. The vinyl-based resin particles thus remain in the thermosetting resin, making it difficult to obtain pores having a size that is substantially the same as that of the vinyl-based resin particles when a thermosetting resin film is produced.

If the 10% thermal decomposition temperature is lower than 300° C., the vinyl-based resin particles added are decomposed before the thermosetting resin is cured. The vinyl-based resin particles thus do not remain in the thermosetting resin, making it difficult to make a thermosetting resin film porous when the film is produced.

In terms of more suitably using the vinyl-based resin particles of the present invention for making a thermosetting resin porous, the vinyl-based resin particles of the present invention preferably have the characteristics that the temperature at 10% mass loss when the particles are heated from 40° C. to 500° C. at a heating rate of 10° C./min in an air atmosphere is 305 to 345° C. and that the mass loss percentage when the particles are heated at 350° C. for 5 hours after they are heated at a heating rate of 10° C./min in an air atmosphere is 88 to 100%.

In terms of even more suitably using the vinyl-based resin particles of the present invention for making a thermosetting resin porous, the vinyl-based resin particles of the present invention more preferably have the characteristics that the temperature at 10% mass loss when the particles are heated from 40° C. to 500° C. at a heating rate of 10° C./min in an air atmosphere is 310 to 340° C. and that the mass loss percentage when the particles are heated at 350° C. for 5 hours after they are heated at a heating rate of 10° C./min in an air atmosphere is 90 to 100%.

### Number Average Particle Diameter

The vinyl-based resin particles of the present invention preferably have a number average particle diameter of 0.2 to 1.5 μm. A number average particle diameter within this range improves the mechanical strength and heat-insulating properties of a porous thermosetting resin film formed using the vinyl-based resin particles of the present invention.

The vinyl-based resin particles of the present invention more preferably have a number average particle diameter of 0.3 to 1.0 μm. A number average particle diameter within this range further improves the mechanical strength and heat-insulating properties of a porous thermosetting resin film formed using the vinyl-based resin particles of the present invention.

The vinyl-based resin particles of the present invention even more preferably have a number average particle diameter of 0.5 to 0.8 μm. A number average particle diameter within this range even further improves the mechanical strength and heat-insulating properties of a porous thermosetting resin film formed using the vinyl-based resin particles of the present invention.

### Coefficient of Variation of Number Average Particle Diameter

In the vinyl-based resin particles of the present invention, the coefficient of variation of the number average particle diameter is preferably 25% or less. A coefficient of variation of the number average particle diameter within this range improves the mechanical strength of a porous thermosetting resin film formed using the vinyl-based resin particles of the present invention.

In the vinyl-based resin particles of the present invention, the coefficient of variation of the number average particle diameter is more preferably 20% or less. A coefficient of variation of the number average particle diameter within this range further improves the mechanical strength of a porous thermosetting resin film formed using the vinyl-based resin particles of the present invention.

The metal (Fe and Ni) content in the vinyl-based resin particles of the present invention is preferably 5 ppm or less, more preferably 3 ppm or less, even more preferably 1.5 ppm or less, and particularly preferably less than 1 ppm (lower limit of quantification). A metal content within this range improves the electrical characteristics when the vinyl-based resin particles of the present invention are used as an insulating material for electronic components because when a thermosetting resin film is produced, the film contains very low amounts of Fe and Ni.

### Proportion of Coarse Particles

In the present specification, the proportion of coarse particles means the proportion of the number of particles having a number average particle diameter that is 2 to 10 times the median diameter (D50) on a number basis with respect to the total number of the vinyl-based resin particles of the present invention.

In the vinyl-based resin particles of the present invention, the proportion of coarse particles is preferably 0 to 5%. When a porous thermosetting resin film is formed using the vinyl-based resin particles of the present invention in which the proportion of coarse particles is within the above range, variations in the diameter of the pores formed in the porous thermosetting resin film are reduced, which improves the mechanical strength of the porous thermosetting resin film.

In the vinyl-based resin particles of the present invention, the proportion of coarse particles is more preferably 0 to 3%. When a porous thermosetting resin film is formed using the vinyl-based resin particles of the present invention in which the proportion of coarse particles is within the above range, variations in the diameter of the pores formed in the porous thermosetting resin film are further reduced, which further improves the mechanical strength of the porous thermosetting resin film.

In the vinyl-based resin particles of the present invention, the proportion of coarse particles is even more preferably 0 to 1%. When a porous thermosetting resin film is formed using the vinyl-based resin particles of the present invention in which the proportion of coarse particles is within the above range, variations in the diameter of the pores formed in the porous thermosetting resin film are even further reduced, which even further improves the mechanical strength of the porous thermosetting resin film.

### Particles A

The vinyl-based resin particles of the present invention are preferably particles having the following features (referred to below as “particles A”):

the particles are formed of a polymer having a polymerizable vinylic monomer unit containing a monofunctional styrenic monomer unit, and the proportion of the monofunctional styrenic monomer unit in the polymerizable vinylic monomer unit is 60 to 100 mass %.

In the particles A, the proportion of the monofunctional styrenic monomer unit in the polymerizable vinylic monomer units is more preferably 70 to 100 mass %, and even more preferably 75 to 100 mass %, in terms of improving the mechanical strength of a porous thermosetting resin film.

In the particles A, the polymerizable vinylic monomer units may comprise a monofunctional (meth)acrylic monomer unit in addition to the monofunctional styrenic monomer unit as long as the effects of the present invention are not impaired.

### Particles B

The vinyl-based resin particles of the present invention are preferably particles having the following features (referred to below as “particles B”):

the particles are formed of a polymer having a polymerizable vinylic monomer unit composed of a monofunctional monomer unit and a polyfunctional monomer unit, and the proportion of the polyfunctional monomer unit in the polymerizable vinylic monomer units is 1 to 15 mass %.

In the particles B, the proportion of the polyfunctional monomer unit in the polymerizable vinylic monomer units is more preferably 1.5 to 13 mass %, even more preferably 2 to 11 mass %, and particularly preferably 2.5 to 9 mass %, in terms of improving the solvent resistance of the particles B.

In the particles B, it is preferable that the monofunctional monomer unit is at least one member selected from the group consisting of a monofunctional styrenic monomer unit and a monofunctional (meth)acrylic monomer unit, and that the polyfunctional monomer unit is at least one member selected from the group consisting of a polyfunctional styrenic monomer unit and a polyfunctional (meth)acrylic monomer unit.

### pH of Vinyl-Based Resin Particles

In the present invention, the pH of a dispersion obtained when the vinyl-based resin particles of the present invention are dispersed in water so that the mass ratio of the vinyl-based resin particles to water is 1:10 (dispersion of the vinyl-based resin particles) is preferably 3 to 9, more preferably 4 to 9, even more preferably 5 to 9, and particularly preferably 7 to 9.

The water may be, for example, natural water, purified water, distilled water, ion-exchanged water, pure water, or the like. Among these, ion-exchanged water is preferable.

Further, ion-exchanged water having a pH in the range of 5.5 to 7 is more preferable.

### Thermosetting Resin

The vinyl-based resin particles of the present invention are used for making a thermosetting resin porous. Examples of thermosetting resins include diallyl phthalate resins, polyimide resins, and the like. The vinyl-based resin particles of the present invention can be particularly suitably used as a pore-forming material for a polyimide resin among these thermosetting resins. When the vinyl-based resin particles of the present invention are used as a pore-forming material for a polyimide resin, uniform pores can be formed in a polyimide resin film.

### 2. Method for Producing Vinyl-Based Resin Particles

The production method A and production method B for vinyl-based resin particles according to the present invention are described below in detail. The present invention is not limited to the following production methods.

### Production Method A for Vinyl-Based Resin Particles

The production method A is a method for producing vinyl-based resin particles, comprising (1) an emulsion polymerization step, (2) a pH adjustment step, (3) a spray-drying step, and (4) a crushing step, in this order. These steps are described in detail below.

The production method A is suitable for producing the particles A described above.

### Emulsion Polymerization Step

In the production method A, the emulsion polymerization step is a step of emulsion-polymerizing a first polymerizable vinylic monomer in an aqueous medium to obtain an aqueous dispersion containing polymer particles of the first polymerizable vinylic monomer and the aqueous medium (slurry containing polymer particles).

Emulsion polymerization is characterized by less variation in the diameter of particles forming the resulting aggregate. For the emulsion polymerization in the production method A, for example, the method described in JP2010-138365A can be applied.

In the production method A, soap-free polymerization, which is emulsion polymerization that does not use a surfactant, is preferable among emulsion polymerization techniques.

In the emulsion polymerization step in the production method A, the first polymerizable vinylic monomer is preferably a monofunctional monomer.

The monofunctional monomer is preferably at least one member selected from the group consisting of a monofunctional styrenic monomer and a monofunctional (meth)acrylic monomer.

Examples of monofunctional styrenic monomers include styrene, o-methylstyrene, m-methylstyrene, p-methylstyrene, α-methylstyrene; styrene sulfonic acid salts, such as sodium styrene sulfonate and ammonium styrene sulfonate; and the like. Of these, styrene, α-methylstyrene, and sodium styrene sulfonate are preferable.

Examples of monofunctional (meth)acrylic monomers include (meth)acrylic monomers, such as (meth)acrylic esters, including methyl (meth)acrylate (methyl methacrylate; MMA), ethyl (meth)acrylate, and butyl (meth)acrylate. Of these, methyl (meth)acrylate is preferable.

In the emulsion polymerization step, the first polymerizable vinylic monomer and one or more other monomers such as a vinyl halide monomer and a vinyl cyanide monomer can be used in combination. Examples of vinyl halide monomers include vinyl chloride, vinylidene chloride, and the like. Examples of vinyl cyanide monomers include acrylonitrile, methacrylonitrile, and the like.

In the emulsion polymerization step, the aqueous medium is, for example, water or a mixed solvent of water and an organic solvent (e.g., a hydrophilic organic solvent such as a lower alcohol having 5 or fewer carbon atoms). The amount of the aqueous medium is preferably 100 to 1000 parts by mass, based on 100 parts by mass of the first polymerizable vinylic monomer, in order to stabilize the vinyl-based resin particles.

Further, in the emulsion polymerization step, a wide variety of known molecular-weight-regulating agents commonly used in this field can be used to regulate the molecular weight. The molecular-weight-regulating agent can be used in an amount of 0.1 to 10 parts by mass, based on 100 parts by mass of the first polymerizable vinylic monomer.

In the emulsion polymerization step, a water-soluble polymerization initiator is generally used. The water-soluble polymerization initiator may be any polymerization initiator that is soluble in an aqueous medium, and known water-soluble polymerization initiators can be used. Examples include peroxides, such as potassium persulfate and ammonium persulfate (APS); and azo compounds, such as 2,2-azobis-(2-methylpropionamidine)-dihydrochloride, 2,2-azobis-[2-(2-imidazolin-2-yl)propane])-dihydrochloride, and 4,4-azobis-(4-cyanovaleric acid). The water-soluble polymerization initiator is generally used in an amount of 0.1 to 5 parts by mass, based on 100 parts by mass of the first polymerizable vinylic monomer.

In the emulsion polymerization step, a wide variety of known surfactants commonly used in this field can be used. Addition of a surfactant suppresses the fusion between the particles that form the polymer obtained by emulsion polymerization. When soap-free polymerization is performed, it is not necessary to add a surfactant.

In the emulsion polymerization step, the average particle diameter can be adjusted by performing seeded emulsion polymerization using seed particles. When emulsion polymerization is performed by adding a monomer mixture, a water-soluble polymerization initiator, and seed particles to an aqueous medium, the polymerization proceeds while the vinylic monomer is absorbed as an oligosoap into the seed particles, and polymer particles having a uniform particle diameter can be obtained.

The seed particles can be obtained by emulsion polymerization, preferably soap-free polymerization, of a monomer for producing seed particles in an aqueous medium.

As the monomer for producing the seed particles, a first polymerizable vinylic monomer described above can be used. Among the first polymerizable vinylic monomers, at least one member selected from the group consisting of a monofunctional styrenic monomer and a monofunctional (meth)acrylic monomer described above is preferably used. Preferable examples of monofunctional styrenic monomers are styrene, α-methylstyrene, and sodium styrene sulfonate. A preferable example of monofunctional (meth)acrylic monomers is methyl (meth)acrylate (methyl methacrylate; MMA).

The aqueous medium for producing the seed particles may be an aqueous medium described above.

In the production of the seed particles, a water-soluble polymerization initiator described above can be used. The water-soluble polymerization initiator is generally used in an amount of 0.1 to 5 parts by mass, based on 100 parts by mass of the monomer for producing the seed particles.

In the production of the seed particles, a wide variety of known molecular-weight-regulating agents commonly used in this field can be used to regulate the molecular weight. It is preferable to use a molecular-weight-regulating agent in an amount of 0.1 to 10 parts by mass, based on 100 parts by mass of the monomer for producing the seed particles.

The polymerization for producing the seed particles can be performed by heating at 50 to 80° C. for 2 to 20 hours.

The polymerization proceeds while the first polymerizable vinylic monomer is absorbed as an oligosoap into the seed particles, thus obtaining polymer particles derived from the polymerizable vinylic monomer.

The polymerization temperature can be appropriately selected depending on the types of first polymerizable vinylic monomer and polymerization initiator. The polymerization temperature is preferably 25 to 110° C., and more preferably 50 to 100° C. The polymerization time is preferably 1 to 12 hours.

### pH Adjustment Step

In the Production method A, the pH adjustment step is a step of adding a nitrogen-containing compound to the aqueous dispersion containing the polymer particles of the first polymerizable vinylic monomer and the aqueous medium (slurry containing the polymer particles) obtained in the emulsion polymerization step to adjust the pH of the aqueous dispersion to 3 to 9.

In the emulsion polymerization step, when soap-free polymerization is performed using persulfuric acid salt as a polymerization initiator, the polymer particles obtained in the production method A are negatively charged because anions such as persulfate ions are present on the surface of the polymer particles. If a polyimide varnish is prepared using the negatively charged vinyl-based resin particles, electrostatic repulsion between polyamic acid, which is a polyimide precursor, and the negatively charged vinyl-based resin particles may occur, which is accompanied by an increase in the viscosity of the polyimide varnish.

It can be surmised that adding a nitrogen-containing compound to the slurry containing the polymer particles suppresses the electrostatic repulsion and prevents an increase in the viscosity of the polyimide varnish because amines derived from the nitrogen-containing compound are present as a cation paired with persulfate ions.

The nitrogen-containing compound is preferably one or more members selected from the group consisting of ammonia, alkanolamines, and polyamines.

Examples of alkanolamines include monoethanolamine, diethanolamine, triethanolamine, isopropanolamine, and the like.

Examples of polyamines include aliphatic amines, such as ethylenediamine, propylenediamine, hexamethylenediamine, diethylenetriamine, and triethylenetetramine; aromatic polyamines, such as phenylenediamine and tolylenediamine; and heterocyclic polyamines, such as piperazine and aminoethylpiperazine.

The presence of amines on the surface of the vinyl-based resin particles can be confirmed by various analysis methods, such as by the change in pH.

Specifically, when soap-free polymerization is performed using persulfuric acid salt as a polymerization initiator, the pH of the slurry is 1 to 2, which is in the strongly acidic range. The presence of amines can be confirmed by adding a nitrogen-containing compound so that the pH is 3 to 9, which is in the weakly acidic to weakly basic range.

In addition, the presence of amines on the surface of the vinyl-based resin particles can also be confirmed by analysis using time-of-flight secondary ion mass spectrometry (TOF-SIMS).

### Spray-Drying Step

In the production method A, the spray-drying step is a step of spray-drying the aqueous dispersion (slurry containing the polymer particles) obtained in the pH adjustment step at an inlet temperature of 80 to 220° C. and an outlet temperature of 50 to 100° C. to obtain an aggregate.

In the spray-drying step, spray drying is performed to obtain an aggregate of vinyl-based resin particles from the slurry containing the polymer particles.

The spray-drying method is generally a method in which the slurry containing the polymer particles is sprayed using a spray-drying apparatus, such as a spray dryer, to dry the particles. The particle diameter, particle shape, and the like of the aggregate of vinyl-based resin particles can be adjusted by appropriately adjusting, for example, the supply rate of the slurry containing the polymer particles, the drying temperature, and the atomizer rotation rate of a spray-drying apparatus in spray drying.

Regarding the drying temperature, the temperature at a slurry inlet through which the slurry containing the polymer particles is introduced by spraying (also referred to below as “the slurry inlet temperature”) is within the range of 80 to 220° C., and the temperature at a powder outlet through which an aggregate of vinyl-based resin particles is discharged is within the range of 50 to 100° C.

If the temperature at the slurry inlet through which the slurry containing the polymer particles is introduced is higher than 220° C., fusion between vinyl-based resin particles is likely to occur, thereby yielding an aggregate of the vinyl-based resin particles in which the vinyl-based resin particles are connected to each other.

If the temperature at the slurry inlet through which the slurry containing the polymer particles is introduced is less than 80° C., the drying is likely to be insufficient, and the drying efficiency is too low.

If the powder outlet temperature is less than 50° C., the drying may be insufficient. If the powder outlet temperature is more than 100° C., fusion between vinyl-based resin particles is likely to occur.

The temperature at the slurry inlet through which the slurry containing the polymer particles is introduced is preferably 90 to 200° C., and the temperature at the powder outlet through which an aggregate of vinyl-based resin particles is discharged is preferably 55 to 95° C.

Further, the temperature at the slurry inlet through which the slurry containing the polymer particles is introduced is preferably 30 to 120° C. higher than the aggregate outlet temperature (the temperature at the powder outlet through which an aggregate of vinyl-based resin particles is discharged), in terms of preventing fusion between vinyl-based resin particles.

### Crushing Step

In the production method A, the crushing step is a step of crushing the aggregate obtained in the spray-drying step to obtain vinyl-based resin particles.

In the crushing step, the aggregate obtained in the spray-drying step can be crushed with high efficiency by using a pulverizer to obtain vinyl-based resin particles.

As the pulverizer, a spiral jet mill, such as a Current Jet Mill or Super Jet Mill (produced by Nisshin Engineering Inc.) can be used.

### Classification Step

The production method A preferably comprises at least one of a first classification step of classifying the polymer particles in the aqueous dispersion obtained in the emulsion polymerization step and a second classification step of classifying the vinyl-based resin particles obtained in the crushing step.

In the first classification step, coarse particles having a size larger than the sieve opening can be removed by wet classification using a nylon mesh. For example, in the first classification step, coarse particles having a size of 32 μm or more can be removed by using, for example, a 400-mesh nylon screen.

In the second classification step, vinyl-based resin particles having a desired particle diameter can be obtained by classification using a classifier, such as an Elbow-Jet inertial classifier (produced by Nittetsu Mining Co., Ltd.), Turboplex centrifugal classifier (produced by Hosokawa Micron Corporation), TSP separator centrifugal classifier (produced by Hosokawa Micron Corporation), or FACULTY (produced by Hosokawa Micron Corporation). For example, in the second classification step, vinyl-based resin particles that can be used as a product can be obtained by air classification.

### Production Method B for Vinyl-Based Resin Particles

The production method B is a method for producing vinyl-based resin particles, comprising (1) a seed polymerization step, (2) a spray-drying step, and (3) a crushing step, in this order. Further, in the seed polymerization step of the production method B, a second polymerizable vinylic monomer comprise a monofunctional monomer and a polyfunctional monomer, and the second polymerizable vinylic monomer comprise the polyfunctional monomer in an amount of 1 to 15 parts by mass based on 100 parts by mass of the monofunctional monomer.

Steps (1) to (3) are described in detail below.

The production method B is suitable for producing the particles B described above.

### Seed Polymerization Step

In the production method B, the seed polymerization step is a step of performing seed polymerization by absorbing second polymerizable vinylic monomer into seed particles to obtain an aqueous dispersion containing polymer particles of the second polymerizable vinylic monomer and an aqueous medium (slurry containing polymer particles).

In the production method B, the seed polymerization means a polymerization method in which second polymerizable vinylic monomer are polymerized after they are impregnated and absorbed into seed particles. For the seed polymerization in the production method B, for example, the method described in JP2010-138365A can be applied.

The seed particles can be produced by applying a known method. For example, the seed particles can be produced by applying the method described in WO2013/030977.

The seed particles can be obtained by emulsion polymerization, preferably soap-free polymerization, of a monomer for producing seed particles in an aqueous medium.

The monomer for producing the seed particles is preferably a monofunctional monomer.

The monofunctional monomer is preferably at least one member selected from the group consisting of a monofunctional styrenic monomer and a monofunctional (meth)acrylic monomer.

Examples of monofunctional styrenic monomers include styrene, o-methylstyrene, m-methylstyrene, p-methylstyrene, α-methylstyrene; styrene sulfonic acid salts, such as sodium styrene sulfonate and ammonium styrene sulfonate; and the like. Of these, styrene, α-methylstyrene, and sodium styrene sulfonate are preferable.

Examples of monofunctional (meth)acrylic monomers include (meth)acrylic monomers, such as (meth)acrylic esters, including methyl (meth)acrylate (methyl methacrylate; MMA), ethyl (meth)acrylate, and butyl (meth)acrylate. Of these, methyl (meth)acrylate is preferable.

The aqueous medium for producing the seed particles is, for example, water or a mixed solvent of water and an organic solvent (e.g., a hydrophilic organic solvent such as a lower alcohol having 5 or fewer carbon atoms). The amount of the aqueous medium is preferably 100 to 1000 parts by mass, based on 100 parts by mass of the monofunctional monomer, in order to stabilize the vinyl-based resin particles.

Moreover, in the seed polymerization step, a wide variety of known polymerization inhibitors commonly used in this field can be used to suppress the formation of emulsion particles in the aqueous medium. Examples of polymerization inhibitors include nitrite compounds, such as sodium nitrite. The polymerization inhibitor can be used in an amount of 0.1 to 10 parts by mass, based on 100 parts by mass of the monofunctional monomer.

Further, in the seed polymerization step, a wide variety of known molecular-weight-regulating agents commonly used in this field can be used to regulate the molecular weight. The molecular-weight-regulating agent can be used in an amount of 0.1 to 10 parts by mass, based on 100 parts by mass of the monofunctional monomer.

In the production of the seed particles, a water-soluble polymerization initiator is generally used. The water-soluble polymerization initiator may be any polymerization initiator that is soluble in an aqueous medium, and known water-soluble polymerization initiators can be used. Examples include peroxides, such as potassium persulfate and ammonium persulfate; and azo compounds, such as 2,2-azobis-(2-methylpropionamidine)-dihydrochloride, 2,2-azobis-[2-(2-imidazolin-2-yl)propane])-dihydrochloride, and 4,4-azobis-(4-cyanovaleric acid).

The water-soluble polymerization initiator is generally used in an amount of 0.1 to 5 parts by mass, based on 100 parts by mass of the monofunctional monomer. Moreover, the polymerization for producing the seed particles can be performed by heating at 50 to 80° C. for 2 to 20 hours.

The second polymerizable vinylic monomer comprise a monofunctional monomer and a polyfunctional monomer, and the second polymerizable vinylic monomer comprise the polyfunctional monomer in an amount of 1 to 15 parts by mass, based on 100 parts by mass of the monofunctional monomer.

In the seed polymerization step, if the amount of the polyfunctional monomer is less than 1 part by mass based on 100 parts by mass of the monofunctional monomer, the solvent resistance of the particles B may be reduced. An amount of the polyfunctional monomer of less than 1 part by mass is also not preferable in terms of handling because the particles B are likely to swell in a solvent when a thermosetting resin precursor is prepared, which may increase the viscosity of the precursor.

In the seed polymerization step, if the amount of the polyfunctional monomer is more than 15 parts by mass based on 100 parts by mass of the monofunctional monomer, it becomes difficult to decompose vinyl-based resin particles added for making a thermosetting resin porous. Thus, the vinyl-based resin particles may remain in the thermosetting resin, making it difficult to make a thermosetting resin film porous when the film is produced.

In the seed polymerization step, the second polymerizable vinylic monomer preferably comprise the polyfunctional monomer in an amount of 1.5 to 13 parts by mass, more preferably 2 to 11 parts by mass, and even more preferably 2.5 to 9 parts by mass, based on 100 parts by mass of the monofunctional monomer, in terms of improving the solvent resistance of the particles B.

In the seed polymerization step, the monofunctional monomer is preferably at least one member selected from the group consisting of a monofunctional styrenic monomer and a monofunctional (meth)acrylic monomer.

Examples of monofunctional styrenic monomers include styrene, o-methylstyrene, m-methylstyrene, p-methylstyrene, α-methylstyrene; styrene sulfonic acid salts, such as sodium styrene sulfonate and ammonium styrene sulfonate; and the like. Of these, styrene, α-methylstyrene, and sodium styrene sulfonate are preferable.

Examples of monofunctional (meth)acrylic monomers include (meth)acrylic monomers, such as (meth)acrylic esters, including methyl (meth)acrylate (methyl methacrylate; MMA), ethyl (meth)acrylate, and butyl (meth)acrylate. Of these, methyl (meth)acrylate is preferable.

In the seed polymerization step, the polyfunctional monomer is at least one member selected from the group consisting of a polyfunctional styrenic monomer and a polyfunctional (meth)acrylic monomer. Using the polyfunctional monomer increases the solvent resistance of the resulting vinyl-based resin particles and suppresses a decrease in the viscosity of a polyimide varnish due to swelling of the resulting vinyl-based resin particles.

Examples of polyfunctional styrenic monomers include divinylbenzene (DVB), divinylnaphthalene, and the like.

Examples of polyfunctional (meth)acrylic monomers include ethylene glycol di(meth)acrylate (ethylene glycol dimethacrylate), trimethylolpropane triacrylate, and the like.

In the seed polymerization step, an oil-soluble polymerization initiator is generally used. The oil-soluble polymerization initiator may be any polymerization initiator that is soluble in an aqueous medium. A known oil-soluble polymerization initiator can be used. Examples include peroxides, such as benzoyl peroxide (BPO), lauroyl peroxide, bis-3,5,5-trimethylhexanoyl peroxide, t-butylperoxy-2-ethylhexanoate, di-t-butylperoxyhexahydroterephthalate, and t-butylperoxy isobutyrate; and azo compounds, such as azobisisobutyronitrile, azobisisovaleronitrile, 2,2-azobis-(2-methylpropionate), and 2,2-azobis-(2,4-dimethylvaleronitrile)(ADVN). The amount of the oil-soluble polymerization initiator is preferably 0.01 to 10 parts by mass, and more preferably 0.01 to 5 parts by mass, based on 100 parts by mass of the total amount of the monofunctional monomer and the polyfunctional monomer.

In the seed polymerization step, a suspension stabilizer can be used to improve polymerization stability in producing polymer particles of the second polymerizable vinylic monomer and to increase the effect of suppressing fusion between the polymer particles. Examples of suspension stabilizers include water-soluble polymers, such as polyvinyl alcohol and polyvinylpyrrolidone.

The amount of the suspension stabilizer is generally 0.5 to 15 parts by mass, based on 100 parts by mass of the total amount of the monofunctional monomer and the polyfunctional monomer.

In the seed polymerization step, a surfactant can be used. Adding a surfactant suppresses fusion between particles forming the polymer particles obtained by seed polymerization. Moreover, emulsifying the monomer mixture using a surfactant in an aqueous medium promotes absorption of the monomer mixture into seed particles in seed polymerization described later.

The surfactant may be an anionic, cationic, nonionic, or zwitterionic surfactant.

Examples of anionic surfactants include dialkylsulfosuccinic acid salts, such as sodium dioctyl sulfosuccinate; phosphoric acid salts, such as sodium polyoxyethylene alkyl phenyl ether phosphate (e.g., sodium polyoxyethylene nonylphenyl ether phosphate) and sodium polyoxyalkylene aryl ether phosphate; fatty acid oils, such as sodium oleate and castor oil potassium; alkyl sulfuric acid salts, such as sodium lauryl sulfate and ammonium lauryl sulfate; alkylbenzene sulfonic acid salts, such as sodium dodecylbenzenesulfonate; alkylnaphthalene sulfonic acid salts; alkanesulfonic acid salts; alkyl phosphoric acid ester salts; naphthalenesulfonic acid-formalin condensates; polyoxyethylene alkylphenyl ether sulfuric acid ester salts; polyoxyethylene alkyl sulfuric acid ester salts; and the like.

Examples of nonionic surfactants include polyoxyethylene alkyl ethers, such as polyoxyethylene tridecyl ether; polyoxyethylene alkylphenyl ether; polyoxyethylene styrenated phenyl ether; polyoxyalkylene alkyl ethers, such as polyoxyalkylene tridecyl ether containing an alkylene group having 3 or more carbon atoms; polyoxyethylene fatty acid ester; sorbitan fatty acid ester; polyoxyethylene sorbitan fatty acid esters, such as polyoxyethylene sorbitan monolaurate; polyoxyethylene alkylamine; glycerol fatty acid ester; oxyethylene-oxypropylene block copolymers; and the like.

Examples of cationic surfactants include alkylamine salts, such as laurylamine acetate and stearylamine acetate; quaternary ammonium salts, such as lauryltrimethylammonium chloride; and the like.

Examples of zwitterionic surfactants include lauryldimethylamine oxide, and phosphoric acid ester or phosphorous acid ester surfactants.

Among the above surfactants, it is preferable to use at least one of an anionic surfactant and a nonionic surfactant. Of the above surfactants, sodium dioctyl sulfosuccinate and sodium polyoxyethylene nonylphenyl ether phosphate are preferable as anionic surfactants, and polyoxyethylene alkylphenyl ether and polyoxyethylene styrenated phenyl ether are preferable as nonionic surfactants.

The amount of surfactant is preferably 1 to 10 parts by mass, and more preferably 1.5 to 8 parts by mass, based on 100 parts by mass of the total amount of the monofunctional monomer and the polyfunctional monomer.

In the seed polymerization step, an antioxidant can be used to improve the heat resistance of vinyl-based resin particles. Examples of usable antioxidants include phenol-based antioxidants, such as 2,6-di-t-butyl-4-methylphenol, n-octadecyl-3-(3′,5′-di-t-butyl-4′-hydroxyphenyl)propionate, tetrakis[3-(3,5-di-t-butyl-4-hydroxyphenyl)propionyloxymethyl]methane, tris[N-(3,5-di-t-butyl-4-hydroxybenzyl)]isocyanurate, butylidene-1,1-bis(2-methyl-4-hydroxy-5-t-butylphenyl), triethylene glycol bis[3-(3-t-butyl-4-hydroxy-5-methylphenyl)propionate], and 3,9-bis{2-[3(3-t-butyl-4-hydroxy-5-methylphenyl)propionyloxy]-1,1-dimethylethyl}-2,4,8,10-tetraoxaspiro[5.5]undecane; sulfur-based antioxidants, such as dilauryl-3,3′-thio-dipropionate, dimyristyl-3,3′-thio-dipropionate, distearyl-3,3′-thio-dipropionate, pentaerythritol tetrakis(3-laurylthio-propionate), pentaerythritol tetrakis thioglycolate (PETG), pentaerythritol thiopropionate, pentaerythritol tetrakis(4-butanate), pentaerythritol tetrakis(6-mercaptohexanate), trimethylolpropane tristhioglycolate, trimethylolpropane tristhiopropionate, trimethylolpropane tristhiobutanate, butanediol bisthioglycolate, ethylene glycol bisthioglycolate, hexanediol bisthioglycolate, butanediol bisthiopropionate, ethylene glycol bisthiopropionate, octyl thioglycolate, 1-octanethiol, 1-dodecanethiol, and thiosalicylic acid; phosphorus-based antioxidants, such as tris(nonylphenyl)phosphite, tris(2,4-di-t-butylphenyl)phosphite, distearyl pentaerythritol diphosphite, bis(2,4-di-t-butylphenyl) pentaerythritol phosphite, and 2,2-methylenebis(4,6-di-t-butylphenyl)-4,4′-biphenylene diphosphonite; and the like. These antioxidants can be used singly or in a combination of two or more.

The amount of antioxidant is preferably 0.01 to 5 parts by mass, and more preferably 0.1 to 1 part by mass, based on 100 parts by mass of the total amount of the monofunctional monomer and the polyfunctional monomer.

### Spray-Drying Step

In the production method B, the spray-drying step is a step of spray-drying the aqueous dispersion (slurry containing the polymer particles) obtained in the seed polymerization step at a slurry inlet temperature of 80 to 220° C. and a powder outlet temperature of 50 to 100° C. to obtain an aggregate.

In the spray-drying step, spray drying is performed to obtain an aggregate of vinyl-based resin particles from the slurry containing the polymer particles.

The spray-drying method is generally a method in which the slurry containing the polymer particles is sprayed using a spray-drying apparatus, such as a spray dryer, to dry the particles. The particle diameter, particle shape, and the like of the aggregate of vinyl-based resin particles can be adjusted by appropriately adjusting, for example, the supply rate of the slurry containing the polymer particles, the drying temperature, and the atomizer rotation rate of a spray-drying apparatus in spray drying.

Regarding the drying temperature, the temperature at a slurry inlet through which the slurry containing the polymer particles is introduced by spraying is within the range of 80 to 220° C., and the temperature at a powder outlet through which an aggregate of vinyl-based resin particles is discharged is within the range of 50 to 100° C. If the temperature at the slurry inlet through which the slurry containing the polymer particles is introduced is higher than 220° C., fusion between vinyl-based resin particles is likely to occur, thereby yielding an aggregate of the vinyl-based resin particles in which the vinyl-based resin particles are connected to each other. If the temperature at the slurry inlet through which the slurry containing the polymer particles is introduced is less than 80° C., the drying is likely to be insufficient, and the drying efficiency is too low.

If the powder outlet temperature is less than 50° C., the drying may be insufficient. If the powder outlet temperature is more than 100° C., fusion between vinyl-based resin particles is likely to occur.

The temperature at the slurry inlet through which the slurry containing the polymer particles is introduced is preferably 90 to 200° C., and the temperature at the powder outlet through which an aggregate of vinyl-based resin particles is discharged is preferably 55 to 95° C.

Further, the temperature at the slurry inlet through which the slurry containing the polymer particles is introduced is preferably 30 to 120° C. higher than the aggregate outlet temperature (the temperature at the powder outlet through which an aggregate of vinyl-based resin particles is discharged), in terms of preventing fusion between vinyl-based resin particles.

### Crushing Step

In the production method B, the crushing step is a step of crushing the aggregate obtained in the spray-drying step to obtain vinyl-based resin particles.

In the crushing step, the aggregate obtained in the spray-drying step can be crushed with high efficiency by using a pulverizer to obtain vinyl-based resin particles.

As the pulverizer, a spiral jet mill, such as a Current Jet Mill or Super Jet Mill (produced by Nisshin Engineering Inc.) can be used.

### Classification Step

The production method B preferably comprises at least one of a first classification step of classifying the polymer particles in the aqueous dispersion obtained in the seed polymerization step and a second classification step of classifying the vinyl-based resin particles obtained in the crushing step.

In the first classification step, coarse particles having a size larger than the sieve opening can be removed by wet classification using a nylon mesh. For example, in the first classification step, coarse particles having a size of 32 μm or more can be removed by using, for example, a 400-mesh nylon screen.

In the second classification step, vinyl-based resin particles having a desired particle diameter can be obtained by classification using a classifier, such as an Elbow-Jet inertial classifier (produced by Nittetsu Mining Co., Ltd.), a Turboplex centrifugal classifier (produced by Hosokawa Micron Corporation), TSP separator centrifugal classifier (produced by Hosokawa Micron Corporation), or FACULTY (produced by Hosokawa Micron Corporation). For example, in the second classification step, vinyl-based resin particles that can be used as a product can be obtained by air classification.

### pH Adjustment Step

The production method B preferably comprises a step of adding a nitrogen-containing compound to the aqueous dispersion (slurry containing the polymer particles) obtained in the seed polymerization step to adjust the pH of the aqueous dispersion to 3 to 9.

The nitrogen-containing compound is preferably one or more members selected from the group consisting of ammonia, alkanolamines, and polyamines.

Examples of alkanolamines include monoethanolamine, diethanolamine, triethanolamine, isopropanolamine, and the like.

Examples of polyamines include aliphatic amines, such as ethylenediamine, propylenediamine, hexamethylenediamine, diethylenetriamine, and triethylenetetramine; aromatic polyamines, such as phenylenediamine and tolylenediamine; and heterocyclic polyamines, such as piperazine and aminoethylpiperazine.

### EXAMPLES

The present invention is described in more detail below with reference to Examples; however, the present invention is not limited to these Examples.

The ion-exchanged water used in the Examples and Comparative Examples is water deionized with an ion exchange resin and having a conductivity of 1.0 μS/cm or less.

First, the evaluation methods, measurement methods, and calculation methods in the Examples and Comparative Examples are described.

### Method for Measuring pH of Vinyl-Based Resin Particles

2 g of the obtained vinyl-based resin particles was added to 20 g of ion-exchanged water and dispersed with a test tube mixer (Tube Mixer TRIO HM-1N produced by AS ONE Corporation) and an ultrasonic homogenizer (Branson Sonifier 450 Advanced produced by Emerson Japan, Ltd.) to obtain a dispersion.

The pH of the obtained dispersion was measured at room temperature (20 to 25° C.) with a handheld pH meter (D-51S produced by Horiba, Ltd.). The obtained pH value was defined as the pH of the vinyl-based resin particles.

### Method for Measuring Number Average Particle Diameter of Seed Particles

The number average particle diameter of seed particles was measured with a laser diffraction scattering particle size distribution analyzer (LS230 produced by Beckman Coulter). Specifically, 0.1 g of a seed particle dispersion (slurry A obtained in Seed Particle Synthesis Example 1, slurry B obtained in Seed Particle Synthesis Example 2, or slurry C obtained in Seed Particle Synthesis Example 3) and 20 ml of a 2 mass % anionic surfactant solution were placed in a test tube, followed by dispersion with a test tube mixer (Tube Mixer TRIO HM-1N produced by AS ONE Corporation) and an ultrasonic cleaner (Ultrasonic Cleaner VS-150 produced by AS ONE Corporation) for 5 minutes, thereby obtaining a dispersion. While irradiating the obtained dispersion with ultrasonic waves, the number average particle diameter of the seed particles in the dispersion was measured with the laser diffraction scattering particle size distribution analyzer.

The measurement conditions of the laser diffraction scattering particle size distribution analyzer are as follows.

### Measurement Conditions of Laser Diffraction Scattering Particle Size Distribution Analyzer

Medium: water
Refractive index of medium: 1.333
Refractive index of solids: refractive index of seed particles
PIDS relative concentration: 40 to 55%

The optical model during the measurement was fitted to the refractive index of the produced seed particles. When one type of monomer was used for the production of seed particles, the refractive index of a homopolymer of the monomer was used as the refractive index of the seed particles. When multiple types of monomers were used for the production of seed particles, the weighted average of the refractive indexes of homopolymers of the monomers in terms of the amounts of the monomers was used as the refractive index of the seed particles.

From the measurement results, particle size distribution based on the number of seed particles was obtained. The arithmetic mean in the particle size distribution on a number basis was defined as the number average particle diameter of seed particles.

### Method for Measuring Number Average Particle Diameter of Vinyl-Based Resin Particles

The number average particle diameter of vinyl-based resin particles was measured with a Coulter Multisizer™ 4e (analyzer produced by Beckman Coulter). The measurement was carried out using an aperture calibrated according to the Multisizer™ 4e user's manual, published by Beckman Coulter.

The aperture used for measurement was suitably selected depending on the size of vinyl-based resin particles to be measured. For example, an aperture having a size of 10 μm was selected for measurement in the particle diameter range of 0.2 to 6 μm, and an aperture having a size of 20 was selected for measurement in the particle diameter range of 0.4 to 16 μm.

The measurement sample used was a dispersion obtained by adding 0.1 g of vinyl-based resin particles to 100 ml of a 2 mass % anionic surfactant aqueous solution and dispersing the particles with an ultrasonic homogenizer (Branson Sonifier 450 Advanced produced by Emerson Japan, Ltd.). During measurement, gentle stirring was performed to an extent in which bubbles were not formed in the beaker. The measurement was ended when the measurement of 100000 vinyl-based resin particles was completed.

From the measurement results, particle size distribution data on a number basis of 100000 vinyl-based resin particles were obtained. The arithmetic mean obtained from the particle size distribution data on a number basis was defined as the number average particle diameter of vinyl-based resin particles.

### Method for Calculating Coefficient of Variation of Number Average Particle Diameter of Vinyl-Based Resin Particles

The coefficient of variation (CV value) of the number average particle diameter of vinyl-based resin particles was calculated according to the following equation.

Coefficient of variation of number average particle diameter of vinyl-based resin particles=[(standard deviation of particle size distribution based on the number of vinyl-based resin particles)/(number average particle diameter of vinyl-based resin particles)]×100

Method for Measuring Proportion of Number of Particles Having Particle Diameter that are 2 to 10 Times Median Diameter (D50) on Number Basis of Vinyl-Based Resin Particles

The proportion of the number of particles in the particle diameter range that is 2 to 10 times the median diameter D50 on a number basis with respect to the total number of vinyl-based resin particles was measured with a Coulter Multisizer™ 4e (analyzer produced by Beckman Coulter), as in the method for measuring the number average particle diameter.

The “median diameter D50 on a number basis” refers to a particle diameter at a cumulative fraction of 50% in particle size distribution on a number basis measured with a Coulter Multisizer™ 4e.

In the particle diameter measurement, an aperture was suitably selected so that a particle diameter range that is 1 to 10 times the median diameter D50 on a number basis could be measured. For example, a 10-μm aperture with the measurable range of 0.2 to 6 μm was selected when the D50 was 0.5 μm, and a 20-μm aperture with the measurable range of 0.4 to 12 μm was selected when the D50 was 1.0 μm.

### Method for Evaluating Proportion of Coarse Particles

The proportion of coarse particles (proportion of the number of particles in the particle diameter range that is 2 to 10 times the median diameter D50 on a number basis with respect to the total number of vinyl-based resin particles) was determined in the following manner.

Specifically, the proportion of the number of particles having a particle diameter that is 2 to 10 times the median diameter D50 on a number basis with respect to the total number of vinyl-based resin particles was measured from the particle size distribution data on a number basis of 100000 vinyl-based resin particles, which was obtained by the method for measuring the number average particle diameter of vinyl-based resin particles described above, to determine the proportion of coarse particles.

The “median diameter D50 on a number basis with respect to the total number of vinyl-based resin particles” refers to a particle diameter at a cumulative fraction of 50% in the particle size distribution on a number basis of 100000 vinyl-based resin particles measured with a Coulter Multisizer™ 4e (analyzer produced by Beckman Coulter).

In the measurement of the number average particle diameter of vinyl-based resin particles, an aperture was suitably selected so that particles having a number average particle diameter that is 1 to 10 times the median diameter D50 on a number basis could be measured. For example, a 10-μm aperture with the measurable range of 0.2 to 6 μm was selected when the D50 was 0.5 μm, and a 20-μm aperture with the measurable range of 0.4 to 12 μm was selected when the D50 was 1.0 μm.

When the proportion of coarse particles measured was 0 to 5%, the proportion of coarse particles was considered to be small.

### Method for Measuring Temperature at 10% Mass Loss

The temperature at 10% mass loss (also referred to as “10% thermal decomposition temperature”) was measured with a TG/DTA6200 thermogravimetric-differential thermal analyzer (produced by SII NanoTechnology Inc.).

First, an aluminum measurement container was filled with about 15 mg of vinyl-based resin particles as a sample at its bottom without any space. The air flow was 200 mL/min, and alumina was used as a reference material.

A mass loss curve (TG/DTA curve) when the temperature was raised from 40° C. to 500° C. at a rate of 10° C./min was then obtained.

The temperature at which the mass was lost by 10% was read from the mass loss curve obtained according to this measurement by using analysis software included with the TGA apparatus, and was defined as the 10% thermal decomposition temperature.

### Method for Measuring Mass Loss Percentage

The mass loss percentage was measured with the thermogravimetric-differential thermal analyzer described above.

First, an aluminum measurement container was filled with about 15 mg of vinyl-based resin particles as a sample at its bottom without any space. The air flow was 200 mL/min, and alumina was used as a reference material.

The mass loss behavior when the particles were heated at 350° C. for 5 hours after being heated from 40° C. to 350° C. at a rate of 10° C./min was then measured.

The mass loss percentage was determined by reading mass loss immediately after heating at 350° C. for 5 hours from a mass loss curve obtained according to this measurement.

### Method for Measuring Metal Content in Vinyl-Based Resin Particles

The metal (Fe and Ni) content in vinyl-based resin particles was measured with a multitype ICP emission spectrometer (ICPE-9000 produced by Shimadzu Corporation).

Specifically, 2.0 g of vinyl-based resin particles was accurately weighed and heated at 450° C. for 3 hours with an electric furnace (STR-15K muffle furnace produced by Isuzu) to be ashed. The ashed vinyl-based resin particles were dissolved in 2 ml of concentrated hydrochloric acid, and distilled water was added to make a total volume of 50 ml, thereby obtaining a measurement sample. The measurement sample was measured with the multitype ICP emission spectrometer under the following measurement conditions to obtain peak intensities at wavelengths of metallic elements (Fe and Ni). Subsequently, the concentrations (μg/ml) of the metallic elements (Fe and Ni) in the measurement sample were determined from the obtained peak intensities at the wavelengths of the metallic elements (Fe and Ni) based on a calibration curve for quantification prepared by the method for preparing a calibration curve described below. The total concentration Tc (μg/ml) of the metallic elements (Fe and Ni) and the weight W (g) of the weighed vinyl-based resin particles were substituted into the following equation to calculate the metal (Fe and Ni) content in the vinyl-based resin particles.

Metal (Fe and Ni) content in vinyl-based resin particles=[Tc (μg/ml)/W (g)]×50 (ml)

### Measurement Conditions

Measurement wavelength: Fe (238.277 nm), Ni (221.716 nm)
Viewing direction: axial direction
Radio frequency output: 1.20 kW
Carrier flow rate: 0.7 L/min
Plasma flow rate: 10.0 L/min
Auxiliary flow rate: 0.6 L/min
Exposure time: 30 seconds

### Method for Preparing Calibration Curve

A standard solution for a calibration curve [XSTC-13 (general-purpose mixed standard solution, mixture of 31 elements (base: 5% HNO₃) each in an amount of about 10 mg/l) produced by SPEX, USA] was serially diluted with distilled water to prepare standard solutions at concentrations of 0 ppm (blank), 0.25 ppm, 1 ppm, 2.5 ppm, and 5 ppm. The standard solution at each concentration was measured with the multitype ICP emission spectrometer under the measurement conditions described above to obtain peak intensities at wavelengths of metallic elements (Fe and Ni). The concentrations and peak intensities of the metallic elements (Fe and Ni) were plotted to determine an approximate line (straight line or quadratic curve) by the least-squares method, and the approximate line was used as a calibration curve for quantification.

### Method for Evaluating Polyimide Porous Film

A polyimide porous film was observed using an SEM at a magnification of 10,000×. 100 pores in the polyimide porous film were randomly selected and subjected to length measurement using a length measurement tool of the SEM to measure the major axis and minor axis of the pores in the polyimide porous film.

The average pore diameter of the pores in the polyimide porous film was defined as follows.

(major axis of pore in polyimide porous film+minor axis of pore in polyimide porous film)/2=average pore diameter of pore in polyimide porous film

When the value obtained by dividing the average pore diameter of the pores in the polyimide porous film, which was determined in the above manner, by the number average particle diameter of the vinyl-based resin particles (average pore diameter of pores in polyimide porous film/number average particle diameter of vinyl-based resin particles) was 0.7 or more and less than 1.5, it was determined that pores equivalent to the number average particle diameter of the vinyl-based resin particles were formed, and the polyimide porous film was evaluated as “A.”

When the value obtained by dividing the average pore diameter by the number average particle diameter of the vinyl-based resin particles was less than 0.7, it means that the pores collapsed because the vinyl-based resin particles decomposed too fast for curing of the polyimide; thus, it was determined that pores equivalent to the number average particle diameter of the vinyl-based resin particles were not formed, and the polyimide porous film was evaluated as “B.”

When the value obtained by dividing the average pore diameter by the number average particle diameter of the vinyl-based resin particles was 1.5 or more, it means that many coarse pores were formed due to the influence of aggregated particles or coarse particles; thus, it was determined that pores equivalent to the number average particle diameter of the vinyl-based resin particles were not formed, and the polyimide porous film was evaluated as “B.”

### Seed Particle Synthesis Example 1

In a polymerization vessel equipped with a stirrer, a thermometer, and a nitrogen gas inlet tube, 80 g of ion-exchanged water as an aqueous medium, 0.02 g of ammonium styrene sulfonate as a monofunctional styrenic monomer (first polymerizable vinylic monomer), and 0.3 g of potassium persulfate as a polymerization initiator were mixed. 20 g of styrene as a monofunctional styrenic monomer (first polymerizable vinylic monomer) was added to the polymerization vessel, and the mixture was heated to 70° C. with stirring while nitrogen gas was bubbled from the nitrogen gas inlet tube. Thereafter, stirring was continued, and soap-free polymerization was performed at an internal temperature of 70° C. for 12 hours to obtain slurry A. The number average particle diameter of seed particles (polystyrene particles) in the obtained slurry A was 0.24 μm.

### Seed Particle Synthesis Example 2

In a polymerization vessel equipped with a stirrer and a thermometer, 20 g of methyl methacrylate (MMA) as a monofunctional (meth)acrylic monomer (first polymerizable vinylic monomer) and 0.4 g of n-octyl mercaptan as a molecular-weight-regulating agent were mixed to prepare an oil phase (referred to below as “oil phase 1”). In another polymerization vessel equipped with a stirrer and a thermometer, 80 g of ion-exchanged water as an aqueous medium, 0.072 g of sodium styrene sulfonate as a monofunctional styrenic monomer (first polymerizable vinylic monomer), and 0.1 g of potassium persulfate as a polymerization initiator were placed. The oil phase 1 was then added to the other polymerization vessel, and the mixture was heated to 70° C. with stirring. Thereafter, stirring was continued, and soap-free polymerization was performed at an internal temperature of 70° C. for 12 hours to obtain slurry B. The number average particle diameter of seed particles (polymethyl methacrylate particles) in the obtained slurry B was 0.28 μm.

### Seed Particle Synthesis Example 3

In a polymerization vessel equipped with a stirrer and a thermometer, 14 g of methyl methacrylate (MMA) as a monofunctional (meth)acrylic monomer (first polymerizable vinylic monomer) and 0.14 g of n-octyl mercaptan as a molecular-weight-regulating agent were mixed to prepare an oil phase (referred to below as “oil phase 2”). In another polymerization vessel equipped with a stirrer and a thermometer, 80 g of ion-exchanged water as an aqueous medium and 0.07 g of potassium persulfate as a polymerization initiator were placed. The oil phase 2 was then added to the other polymerization vessel, and the mixture was heated to 70° C. with stirring. Thereafter, stirring was continued, and soap-free polymerization was performed at an internal temperature 70° C. for 12 hours to obtain slurry C. The number average particle diameter of seed particles (polymethyl methacrylate particles) in the obtained slurry C was 0.45 μm.

### Example 1

In a polymerization vessel equipped with a stirrer, a thermometer, and a nitrogen gas inlet tube, 73 g of ion-exchanged water as an aqueous medium and 0.18 g of ammonium persulfate as a polymerization initiator were mixed. 18 g of styrene as a monofunctional styrenic monomer (first polymerizable vinylic monomer) and 9 g of the slurry A obtained in Seed Particle Synthesis Example 1 were added to the polymerization vessel, and the mixture was heated to 80° C. with stirring while nitrogen gas was bubbled from the nitrogen gas inlet tube. Thereafter, stirring was continued, and soap-free polymerization was performed at an internal temperature of 80° C. for 12 hours to obtain a slurry containing polymer particles (aqueous dispersion containing polymer particles of the first polymerizable vinylic monomer and the aqueous medium). The pH of the slurry containing polymer particles was measured with a handheld pH meter (D-51S; produced by Horiba, Ltd.) and found to be 2.

Thereafter, 0.1 g of a 28 mass % ammonia aqueous solution was added to 100 g of the slurry containing polymer particles, followed by stirring at 20° C. for 10 minutes to introduce amines on the surface of the polymer particles. The pH of the slurry measured after stirring was 8.

The slurry after pH measurement was passed through a 400-mesh nylon screen to classify the polymer particles, thereby obtaining a slurry containing the classified polymer particles.

The slurry containing the classified polymer particles was spray-dried under the following conditions using a spray drying apparatus (produced by Sakamoto Giken; machine name: spray dryer; type: atomizer take-up system; model number: TRS-3WK) to obtain an aggregate of vinyl-based resin particles.

### Apparatus Conditions

Supply rate of slurry containing polymer particles: 25 ml/min
Atomizer rotation rate: 9000 rpm
Air flow: 2 m³/min
Inlet temperature (temperature at a slurry inlet that is provided in the spray dryer and through which a slurry containing polymer particles is sprayed and introduced): 130° C.
Outlet temperature (temperature at a powder outlet that is provided in the spray dryer and through which an aggregate of vinyl-based resin particles is discharged): 60° C.

The obtained aggregate of vinyl-based resin particles was crushed using a Current Jet Mill (produced by Nisshin Engineering Inc.; trade name: CJ-10; grinding air pressure: 0.5 MPa) to obtain vinyl-based resin particles.

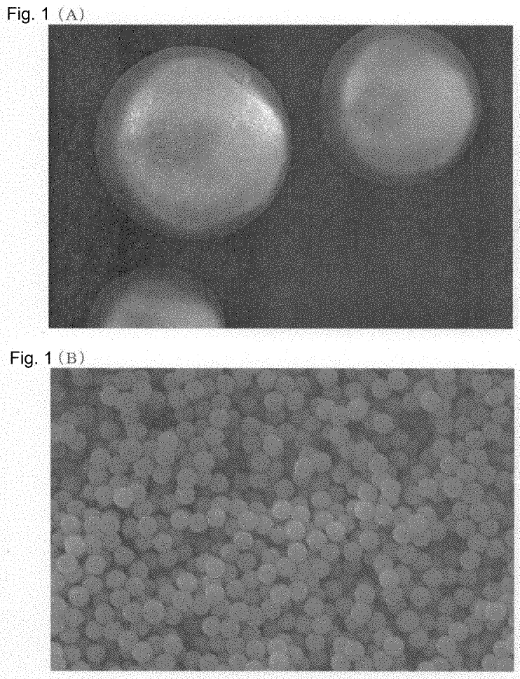

FIG. 1(A) and FIG. 1(B) are photographs of the aggregate of vinyl-based resin particles and the vinyl-based resin particles after crushing observed with a scanning electron microscope (SEM).

The number average particle diameter of the obtained vinyl-based resin particles was 0.587 μm, and the coefficient of variation of the number average particle diameter was 18.4%. The proportion of the number of particles having a number average particle diameter that was 2 to 10 times the median diameter D50 on a number basis with respect to the total number was 0.07%.

The pH of the obtained vinyl-based resin particles was 7.4.

The 10% thermal decomposition temperature (temperature at 10% mass loss) when the obtained vinyl-based resin particles were heated to 500° C. at a heating rate of 10° C./min in an air atmosphere was 340° C. Moreover, when the vinyl-based resin particles were heated at 350° C. for 5 hours after being heated at a heating rate of 10° C./min in an air atmosphere, the mass loss percentage was 92%.

The Fe content and Ni content in the obtained vinyl-based resin particles were each below the lower limit of quantification (1 ppm).

### Example 2

In a polymerization vessel equipped with a stirrer and a thermometer, 29.7 g of styrene as a monofunctional styrenic monomer (second polymerizable vinylic monomer), 1.5 g of ethylene glycol di(meth)acrylate as a polyfunctional (meth)acrylic monomer (second polymerizable vinylic monomer), and 0.17 g of benzoyl peroxide as a polymerization initiator were mixed to obtain a monomer mixture. 62.5 g of ion-exchanged water as an aqueous medium, 0.17 g of sodium dioctyl sulfosuccinate as an anionic surfactant, 0.33 g of sodium polyoxyethylene nonylphenyl ether phosphate as an anionic surfactant, 0.33 g of polyoxyethylene styrenated phenyl ether as a nonionic surfactant, and 0.01 g of sodium nitrite as a polymerization inhibitor were added to the obtained monomer mixture. The mixture was then stirred at 8000 rpm for 10 minutes with a T.K. HOMO MIXER (produced by PRIMIX Corporation) to obtain a monomer mixture.

6.3 g of the slurry B obtained in Seed Particle Synthesis Example 2 was added to the monomer mixture with stirring, and stirring was performed at 30° C. for 3 hours to absorb the monomer mixture into the seed particles. Thereafter, while stirring, the internal temperature of the polymerization vessel was raised to 75° C. and kept at 75° C. for 5 hours to carry out seed polymerization for 5 hours. The internal temperature of the polymerization vessel was then raised to 105° C. and kept at 105° C. for 3 hours to further carry out seed polymerization for 3 hours, thereby obtaining a slurry containing polymer particles (aqueous dispersion containing polymer particles of the second polymerizable vinylic monomer and the aqueous medium).

The slurry containing polymer particles was passed through a 400-mesh nylon screen to classify the polymer particles, thereby obtaining a slurry containing the classified polymer particles.

The slurry containing the classified polymer particles was spray-dried under the following conditions using a spray drying apparatus (produced by Sakamoto Giken; machine name: spray dryer; type: atomizer take-up system; model number: TRS-3WK) to obtain an aggregate of vinyl-based resin particles.

### Apparatus Conditions

Supply rate of slurry containing polymer particles: 25 ml/min
Atomizer rotation rate: 12000 rpm
Air flow: 2 m³/min
Inlet temperature (temperature at a slurry inlet that is provided in the spray dryer and through which a slurry containing polymer particles is sprayed and introduced): 150° C.
Outlet temperature (temperature at a powder outlet that is provided in the spray dryer and through which an aggregate of vinyl-based resin particles is discharged): 70° C.

The obtained aggregate of vinyl-based resin particles was crushed using a Current Jet Mill (produced by Nisshin Engineering Inc.; trade name: CJ-10; grinding air pressure: 0.5 MPa) to obtain vinyl-based resin particles.

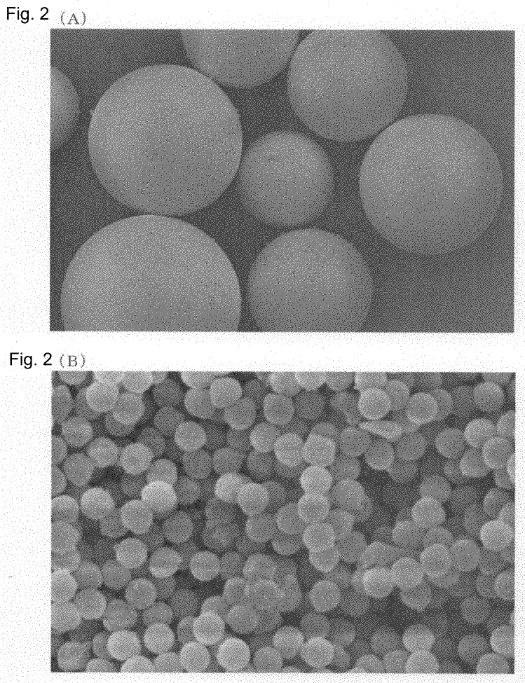

FIG. 2(A) and FIG. 2(B) are photographs of the aggregate of vinyl-based resin particles and the vinyl-based resin particles after crushing observed with an SEM.

The number average particle diameter of the obtained vinyl-based resin particles was 0.781 μm, and the coefficient of variation of the number average particle diameter was 19.0%. The proportion of the number of particles having a number average particle diameter that was 2 to 10 times the median diameter D50 on a number basis with respect to the total number was 0%.

The pH of the obtained vinyl-based resin particles was 4.0.

The 10% thermal decomposition temperature when the obtained vinyl-based resin particles were heated to 500° C. at a heating rate of 10° C./min in an air atmosphere was 310° C. Moreover, when the vinyl-based resin particles were heated at 350° C. for 5 hours after being heated at a heating rate of 10° C./min in an air atmosphere, the mass loss percentage was 94%.

The Fe content and Ni content in the obtained vinyl-based resin particles were each below the lower limit of quantification (1 ppm).

### Example 3

A slurry containing polymer particles was obtained under the same conditions as in Example 2, except that the amount of styrene was 28.4 g, the amount of benzoyl peroxide was 0.20 g, the amount of ion-exchanged water was 59.5 g, and 10.6 g of the slurry C obtained in Seed Particle Synthesis Example 3 was used in place of 6.3 g of the slurry B obtained in Seed Particle Synthesis Example 2.

The slurry containing polymer particles were then subjected to classification, spray drying, and crushing under the same conditions as in Example 2, thereby obtaining vinyl-based resin particles.

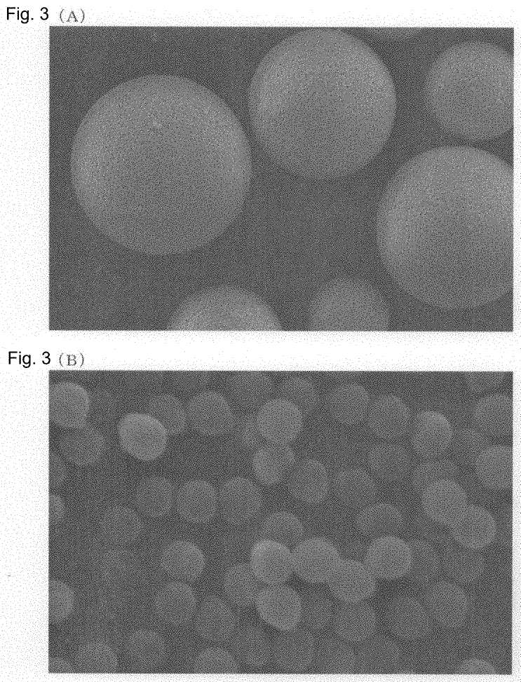

FIG. 3(A) and FIG. 3(B) are photographs of the aggregate of vinyl-based resin particles and the vinyl-based resin particles after crushing observed with an SEM.

The number average particle diameter of the obtained vinyl-based resin particles was 1.241 μm, and the coefficient of variation of the number average particle diameter was 19.5%. The proportion of the number of particles having a number average particle diameter that was 2 to 10 times the median diameter D50 on a number basis with respect to the total number was 0.72%.

The pH of the obtained vinyl-based resin particles was 4.0.

The 10% thermal decomposition temperature when the obtained vinyl-based resin particles were heated to 500° C. at a heating rate of 10° C./min in an air atmosphere was 312° C. Moreover, when the vinyl-based resin particles were heated at 350° C. for 5 hours after being heated at a heating rate of 10° C./min in an air atmosphere, the mass loss percentage was 92%.

The Fe content and Ni content in the obtained vinyl-based resin particles were each below the lower limit of quantification (1 ppm).

### Example 4

A slurry containing polymer particles was obtained under the same conditions as in Example 2, except that the amount of styrene was 28.7 g, and the amount of ethylene glycol di(meth)acrylate was 2.5 g.

The slurry containing polymer particles was then subjected to classification, spray drying, and crushing under the same conditions as in Example 2, thereby obtaining vinyl-based resin particles.

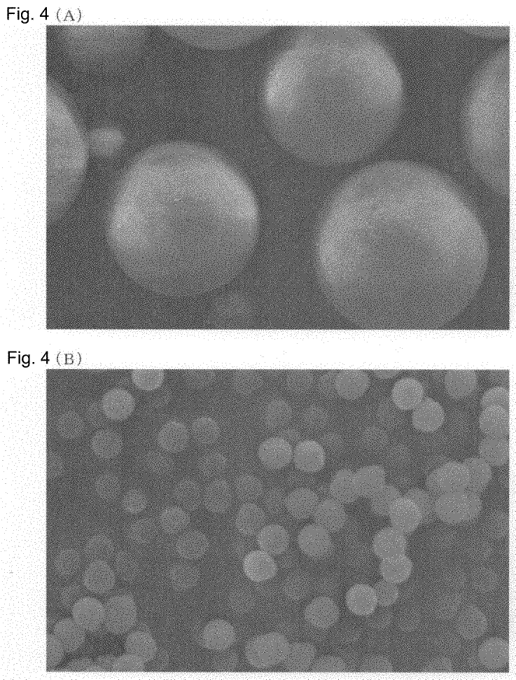

FIG. 4(A) and FIG. 4(B) are photographs of the aggregate of vinyl-based resin particles and the vinyl-based resin particles after crushing observed with an SEM.

The number average particle diameter of the obtained vinyl-based resin particles was 0.828 μm, and the coefficient of variation of the number average particle diameter was 15.6%. The proportion of the number of particles having a number average particle diameter that was 2 to 10 times the median diameter D50 on a number basis with respect to the total number was 0.12%.

The pH of the obtained vinyl-based resin particles was 4.0.

The 10% thermal decomposition temperature when the obtained vinyl-based resin particles were heated to 500° C. at a heating rate of 10° C./min in an air atmosphere was 308° C. Moreover, when the vinyl-based resin particles were heated at 350° C. for 5 hours after being heated at a heating rate of 10° C./min in an air atmosphere, the mass loss percentage was 92%.

The Fe content and Ni content in the obtained vinyl-based resin particles were each below the lower limit of quantification (1 ppm).

### Example 5

In a polymerization vessel equipped with a stirrer and a thermometer, 28.7 g of methyl methacrylate (MMA) as a monofunctional (meth)acrylic monomer (second polymerizable vinylic monomer), 0.28 g of styrene as a monofunctional styrenic monomer (second polymerizable vinylic monomer), 0.28 g of methyl acrylate as a monofunctional (meth)acrylic monomer (second polymerizable vinylic monomer), 1.5 g of ethylene glycol dimethacrylate as a polyfunctional (meth)acrylic monomer (second polymerizable vinylic monomer), 0.44 g of pentaerythritol tetrakis thioglycolate as an antioxidant, 0.17 g of 2,2-azobis-(2,4-dimethylvaleronitrile) as a polymerization initiator were mixed. Further, 62.5 g of ion-exchanged water as an aqueous medium, 0.17 g of sodium dioctyl sulfosuccinate as an anionic surfactant, 0.33 g of sodium polyoxyethylene alkyl ether phosphate as an anionic surfactant, 0.33 g of polyoxyethylene styrenated phenyl ether as a nonionic surfactant, and 0.01 g of sodium nitrite as a polymerization inhibitor were added to the polymerization vessel. Thereafter, the mixture was stirred at 8000 rpm for 10 minutes with a T.K. HOMO MIXER (produced by PRIMIX Corporation) to obtain a monomer mixture.

6.3 g of the slurry B obtained in Seed Particle Synthesis Example 2 was added to the monomer mixture with stirring. Stirring was performed at 30° C. for 3 hours to absorb the monomer mixture into the seed particles. Thereafter, while stirring, the internal temperature of the polymerization vessel was raised to 50° C. and kept at 50° C. for 5 hours to carry out seed polymerization for 5 hours. The internal temperature of the polymerization vessel was then raised to 105° C. and kept at 105° C. for 3 hours to further carry out seed polymerization for 3 hours, thereby obtaining a slurry containing polymer particles.

Thereafter, the slurry containing polymer particles was subjected to classification, spray drying, and crushing under the same conditions as in Example 2, thereby obtaining vinyl-based resin particles.

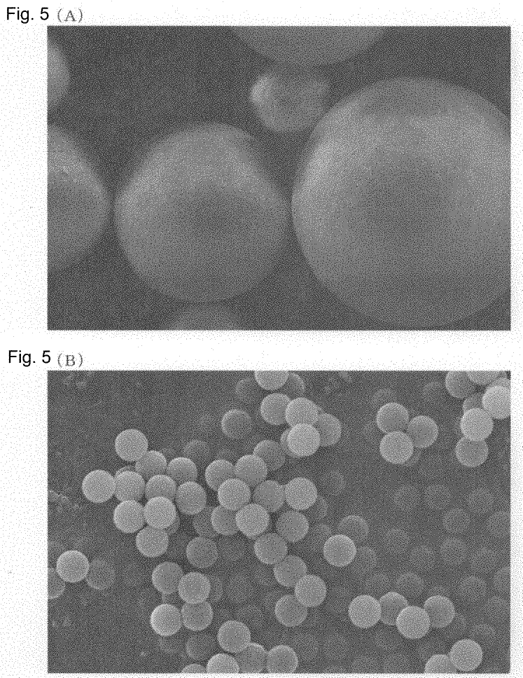

FIG. 5(A) and FIG. 5(B) are photographs of the aggregate of vinyl-based resin particles and the vinyl-based resin particles after crushing observed with an SEM.

The number average particle diameter of the obtained vinyl-based resin particles was 0.810 μm, and the coefficient of variation of the number average particle diameter was 14.4%. The proportion of the number of particles having a number average particle diameter that was 2 to 10 times the median diameter D50 on a number basis with respect to the total number was 1.6%.

The pH of the obtained vinyl-based resin particles was 3.8.

The 10% thermal decomposition temperature when the obtained vinyl-based resin particles were heated to 500° C. at a heating rate of 10° C./min in an air atmosphere was 312° C. Moreover, when the vinyl-based resin particles were heated at 350° C. for 5 hours after being heated at a heating rate of 10° C./min in an air atmosphere, the mass loss percentage was 95%.

The Fe content and Ni content in the obtained vinyl-based resin particles were each below the lower limit of quantification (1 ppm).

### Comparative Example 1

In a polymerization vessel equipped with a stirrer and a thermometer, 21.2 g of n-butyl acrylate and 0.62 g of n-methyl acrylate as monofunctional (meth)acrylic monomer (second polymerizable vinylic monomer), 9.4 g of ethylene glycol dimethacrylate as a polyfunctional (meth)acrylic monomer (second polymerizable vinylic monomer), and 0.17 g of 2,2-azobis-(2,4-dimethylvaleronitrile) as a polymerization initiator were mixed. Further, 62.5 g of ion-exchanged water as an aqueous medium, 0.17 g of sodium dioctyl sulfosuccinate as an anionic surfactant, 0.33 g of sodium polyoxyethylene alkyl ether phosphate as an anionic surfactant, 0.33 g of polyoxyethylene styrenated phenyl ether as a nonionic surfactant, and 0.01 g of sodium nitrite as a polymerization inhibitor were added to the polymerization vessel. The mixture was then stirred at 8000 rpm for 10 minutes with a T.K. HOMO MIXER (produced by PRIMIX Corporation) to obtain a monomer mixture.

6.3 g of the slurry B obtained in Seed Particle Synthesis Example 2 was added to the monomer mixture with stirring. Stirring was performed at 30° C. for 3 hours to absorb the monomer mixture into the seed particles. Thereafter, while stirring, the internal temperature of the polymerization vessel was raised to 50° C. and kept at 50° C. for 5 hours to carry out seed polymerization for 5 hours. The internal temperature of the polymerization vessel was then raised to 105° C. and kept at 105° C. for 3 hours to further carry out seed polymerization for 3 hours, thereby obtaining a slurry containing polymer particles.

Thereafter, the slurry containing polymer particles were subjected to classification, spray drying, and crushing under the same conditions as in Example 2, thereby obtaining vinyl-based resin particles.

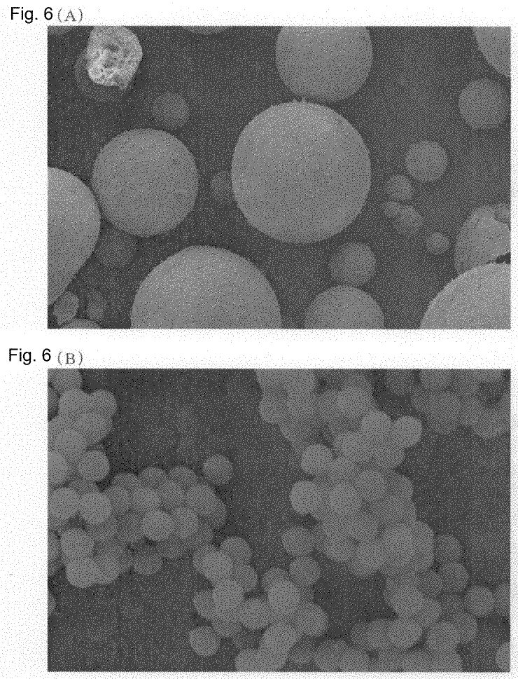

FIG. 6(A) and FIG. 6(B) are photographs of the aggregate of vinyl-based resin particles and the vinyl-based resin particles after crushing observed with an SEM.

The number average particle diameter of the obtained vinyl-based resin particles was 0.810 μm, and the coefficient of variation was 19.0%. The proportion of the number of particles having a number average particle diameter that was 2 to 10 times the median diameter D50 on a number basis with respect to the total number was 1.20%.

The pH of the obtained vinyl-based resin particles was 3.5.

The 10% thermal decomposition temperature when the obtained vinyl-based resin particles were heated to 500° C. at a heating rate of 10° C./min in an air atmosphere was 276° C. Moreover, when the vinyl-based resin particles were heated at 350° C. for 5 hours after being heated at a heating rate of 10° C./min in an air atmosphere, the mass loss percentage was 80%.

### Comparative Example 2

A slurry containing polymer particles was obtained under the same conditions as in Example 2, except that the amount of styrene was 24.7 g, and the amount of ethylene glycol di(meth)acrylate was 6.5 g.

The slurry containing polymer particles was then subjected to classification and spray drying under the same conditions as in Example 2.

Thereafter, the obtained aggregate of vinyl-based resin particles was subjected to crushing under the same conditions as in Example 2, thereby obtaining vinyl-based resin particles.

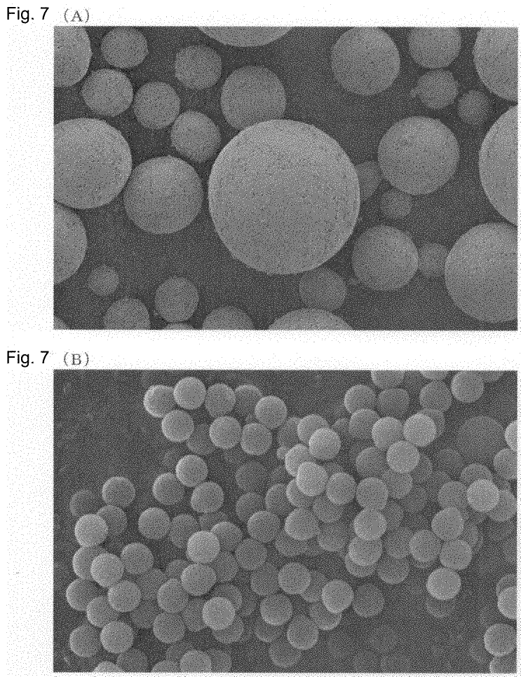

FIG. 7(A) and FIG. 7(B) are photographs of the aggregate of vinyl-based resin particles and the vinyl-based resin particles after crushing observed with an SEM.

The number average particle diameter of the obtained vinyl-based resin particles was 0.822 μm, and the coefficient of variation was 18.5%. The proportion of the number of particles having a number average particle diameter that was 2 to 10 times the median diameter D50 on a number basis with respect to the total number was 0.8%.

The pH of the obtained vinyl-based resin particles was 4.0.

The 10% thermal decomposition temperature when the obtained vinyl-based resin particles were heated to 500° C. at a heating rate of 10° C./min in an air atmosphere was 312° C. Moreover, when the vinyl-based resin particles were heated at 350° C. for 5 hours after being heated at a heating rate of 10° C./min in an air atmosphere, the mass loss percentage was 72%.

### Test Example 1

In a beaker, 8 g of the vinyl-based resin particles obtained in Example 1 and 24 g of ethanol were mixed to prepare a particle dispersion. In another beaker, 3.61 g of a solution of N-methylpyrrolidone (U-Varnish A produced by Ube Industries, Ltd.), which is a polyimide precursor, and 1.8 g of N,N-dimethylacetamide (DMAc) as an organic solvent were mixed, and 6 g of the prepared particle dispersion was added. The mixture was then stirred and deaerated with a deaerating stirrer (produced by Kurabo Industries Ltd.; trade name: MAZERUSTAR KK; model number: 250S) for 15 minutes to obtain a polyimide varnish.

The obtained polyimide varnish was applied to a silicone-coated polyethylene terephthalate (PET) film as a release material with a coater (IMC-70F0-C produced by Imoto Machinery Co., Ltd.) and an applicator (Baker Applicator YBA produced by Yoshimitsu Seiki) and dried at 60° C. for 1 hour to obtain an unfired composite film containing vinyl-based resin particles (film thickness: about 45 μm).

The unfired composite film was peeled off from the PET film and heated from 20° C. to 320° C. at a heating rate of 10° C./min in an air atmosphere with a microwave muffle furnace (Phoenix produced by CEM). Thereafter, the film was heated at 320° C. for 5 hours, thereby producing a polyimide porous film as a polyimide porous body.

The pore diameter of the produced polyimide porous film was measured using a length measurement tool of an SEM and found to be 0.545 μm.

The value obtained by dividing the average pore diameter by the number average particle diameter of the vinyl-based resin particles obtained in Example 1, i.e., 0.587 μm was 0.93, confirming that pores equivalent to the number average particle diameter of the vinyl-based resin particles were formed in the polyimide porous film.

### Test Example 2

A polyimide porous film was produced as a polyimide porous body under the same conditions as in Test Example 1, except that 8 g of the vinyl-based resin particles obtained in Example 2 was used in place of 8 g of the vinyl-based resin particles obtained in Example 1.

The pore diameter of the produced polyimide porous film was measured using a length measurement tool of an SEM and found to be 0.768 μm.

The value obtained by dividing the average pore diameter by the number average particle diameter of the vinyl-based resin particles obtained in Example 2, i.e., 0.781 μm, was 0.98, confirming that pores equivalent to the number average particle diameter of the vinyl-based resin particles were formed in the polyimide porous film.

### Test Example 3

A polyimide porous film was produced as a polyimide porous body under the same conditions as in Test Example 1, except that 8 g of the vinyl-based resin particles obtained in Example 3 was used in place of 8 g of the vinyl-based resin particles obtained in Example 1.

The pore diameter of the produced polyimide porous film was measured using a length measurement tool of an SEM and found to be 1.30 μm.

The value obtained by dividing the average pore diameter by the number average particle diameter of the vinyl-based resin particles obtained in Example 3, i.e., 1.241 μm, was 1.05, confirming that pores equivalent to the number average particle diameter of the vinyl-based resin particles were formed in the polyimide porous film.

### Test Example 4

A polyimide porous film was produced as a polyimide porous body under the same conditions as in Test Example 1, except that 8 g of the vinyl-based resin particles obtained in Example 4 was used in place of 8 g of the vinyl-based resin particles obtained in Example 1.

The pore diameter of the produced polyimide porous film was measured using a length measurement tool of an SEM and found to be 0.712 μm.

The value obtained by dividing the average pore diameter by the number average particle diameter of the vinyl-based resin particles obtained in Example 4, i.e., 0.828 μm, was 0.86, confirming that pores equivalent to the number average particle diameter of the vinyl-based resin particles were formed in the polyimide porous film.

### Test Example 5

A polyimide porous film was produced as a polyimide porous body under the same conditions as in Test Example 1, except that 8 g of the vinyl-based resin particles obtained in Example 5 was used in place of 8 g of the vinyl-based resin particles obtained in Example 1.

The pore diameter of the produced polyimide porous film was measured using a length measurement tool of an SEM and found to be 0.785 μm.

The value obtained by dividing the average pore diameter by the number average particle diameter of the vinyl-based resin particles obtained in Example 5, i.e., 0.810 μm, was 0.97, confirming that pores equivalent to the number average particle diameter of the vinyl-based resin particles were formed in the polyimide porous film.

### Test Example 6

A polyimide porous film was produced as a polyimide porous body under the same conditions as in Test Example 1, except that 8 g of the vinyl-based resin particles obtained in Comparative Example 1 was used in place of 8 g of the vinyl-based resin particles obtained in Example 1.

The pore diameter of the produced polyimide porous film was measured using a length measurement tool of an SEM and found to be 0.294 μm.

The value obtained by dividing the average pore diameter by the number average particle diameter of the vinyl-based resin particles obtained in Comparative Example 1, i.e., 0.810 μm, was 0.36, confirming that pores equivalent to the number average particle diameter of the vinyl-based resin particles were not formed in the polyimide porous film.

### Test Example 7

A polyimide porous film was produced as a polyimide porous body under the same conditions as in Test Example 1, except that 8 g of the vinyl-based resin particles obtained in Comparative Example 2 was used in place of 8 g of the vinyl-based resin particles obtained in Example 1.

The pore diameter of the produced polyimide porous film was measured using a length measurement tool of an SEM and found to be 0.525 μm.

The value obtained by dividing the average pore diameter by the number average particle diameter of the vinyl-based resin particles obtained in Comparative Example 1, i.e., 0.822 μm, was 0.64, confirming that pores equivalent to the number average particle diameter of the vinyl-based resin particles were not formed in the polyimide porous film.

### Evaluation

Table 1 shows the results of the Examples, Comparative Examples, and Test Examples. In Table 1, the proportion (%) of coarse particles refers to the proportion (%) of the number of particles in the particle diameter range that is 2 to 10 times the median diameter D50 on a number basis with respect to the total number of vinyl-based resin particles.

TABLE 1

| | | Example | Example | Example | Example |
|---|---|---|---|---|---|
| | | 1 | 2 | 3 | 4 |
| Monofunctional | Styrene | 18 | 29.7 | 28.4 | 28.7 |
| monomer [g] | Methyl methacrylate | — | — | — | — |
| | Butyl acrylate | — | — | — | — |
| | Methyl acrylate | — | — | — | — |
| Polyfunctional | Ethylene glycol | — | 1.5 | 1.5 | 2.5 |
| monomer [g] | dimethacrylate | | | | |
| Antioxidant [g] | Pentaerythritol tetrakis | — | — | — | — |
| | thioglycolate | | | | |
| Type of slurry (A, B, or C)/ | | A/9 | B/6.3 | C/10.6 | B/6.3 |
| amount of slurry [g] | | | | | |
| Ion-exchanged water [g] | | 73 | 62.5 | 59.5 | 62.5 |
| Polymerization | Ammonium persulfate | 0.18 | — | — | — |
| initiator [g] | Benzoyl peroxide | — | 0.17 | 0.20 | 0.17 |
| | 2,2-azobis-(2,4- | — | — | — | — |
| | dimethylvaleronitrile) | | | | |

| | | | | |
|---|---|---|---|---|
| Number average particle diameter | 0.587 | 0.781 | 1.241 | 0.828 |
| of vinyl-based resin particles [μm] | | | | |
| Coefficient of variation of number average particle | 18.4 | 19.0 | 19.5 | 15.6 |
| diameter of vinyl-based resin particles [%] | | | | |
| Proportion of coarse particles [%] | 0.07 | 0 | 0.72 | 0.12 |
| Temperature at 10% mass loss (10% thermal | 340 | 310 | 312 | 308 |
| decomposition temperature) [° C.] | | | | |
| pH of vinyl-based resin particles | 7.4 | 4.0 | 4.0 | 4.0 |
| Mass loss percentage after heating at | 92 | 94 | 92 | 92 |
| 350° C. for 5 hours [%] | | | | |
| Evaluation of polyimide porous film | A | A | A | A |
| Average pore diameter of pores of polyimide porous film/number | 0.93 | 0.98 | 1.05 | 0.86 |
| average particle diameter of vinyl-based resin particles | | | | |

| | | Example | Comparative | Comparative |
|---|---|---|---|---|
| | | 5 | Example 1 | Example 2 |
| Monofunctional | Styrene | 0.28 | — | 24.7 |
| monomer [g] | Methyl methacrylate | 28.7 | — | — |
| | Butyl acrylate | — | 21.2 | — |
| | Methyl acrylate | 0.28 | 0.62 | — |
| Polyfunctional | Ethylene glycol | 1.5 | 9.4 | 6.5 |
| monomer [g] | dimethacrylate | | | |
| Antioxidant [g] | Pentaerythritol tetrakis | 0.44 | — | — |
| | thioglycolate | | | |
| Type of slurry (A, B, or C)/ | | B/6.3 | B/6.3 | B/6.3 |
| amount of slurry [g] | | | | |
| Ion-exchanged water [g] | | 62.5 | 62.5 | 62.5 |
| Polymerization | Ammonium persulfate | — | — | — |
| initiator [g] | Benzoyl peroxide | — | — | 0.17 |
| | 2,2-azobis-(2,4- | 0.17 | 0.17 | — |
| | dimethylvaleronitrile) | | | |

| | | | |
|---|---|---|---|
| Number average particle diameter | 0.810 | 0.810 | 0.822 |
| of vinyl-based resin particles [μm] | | | |
| Coefficient of variation of number average particle | 14.4 | 19.0 | 18.5 |
| diameter of vinyl-based resin particles [%] | | | |
| Proportion of coarse particles [%] | 1.6 | 1.2 | 0.8 |
| Temperature at 10% mass loss (10% thermal | 312 | 276 | 312 |
| decomposition temperature) [° C.] | | | |
| pH of vinyl-based resin particles | 3.8 | 3.5 | 4.0 |
| Mass loss percentage after heating at | 95 | 80 | 72 |
| 350° C. for 5 hours [%] | | | |
| Evaluation of polyimide porous film | A | B | B |
| Average pore diameter of pores of polyimide porous film/number | 0.97 | 0.36 | 0.64 |
| average particle diameter of vinyl-based resin particles | | | |

1. Vinyl-based resin particles for use in making a thermosetting resin porous,
the particles having a temperature of 300 to 350° C. at 10% mass loss when heated at a rate of 10° C./min in an air atmosphere, and
the particles having a mass loss percentage of 85 to 100% after being heated at 350° C. for 5 hours in an air atmosphere.

2. The vinyl-based resin particles according to claim 1, which have a number average particle diameter of 0.2 to 1.5 μm.

3. The vinyl-based resin particles according to claim 2, wherein the coefficient of variation of the number average particle diameter is 25% or less.

4. The vinyl-based resin particles according to claim 1, wherein the proportion of the number of particles having a number average particle diameter that is 2 to 10 times the median diameter (D50) on a number basis is 0 to 5%.

5. The vinyl-based resin particles according to claim 1, wherein the vinyl-based resin particles are formed of a polymer having a polymerizable vinylic monomer unit containing a monofunctional styrenic monomer unit, and the proportion of the monofunctional styrenic monomer unit in the polymerizable vinylic monomer unit is 60 to 100 mass %.

6. The vinyl-based resin particles according to claim 1, wherein the vinyl-based resin particles are formed of a polymer having a polymerizable vinylic monomer unit composed of a monofunctional monomer unit and a polyfunctional monomer unit, and the proportion of the polyfunctional monomer unit in the polymerizable vinylic monomer unit is 1 to 15 mass %.

7. The vinyl-based resin particles according to claim 6, wherein the monofunctional monomer unit is at least one member selected from the group consisting of a monofunctional styrenic monomer unit and a monofunctional (meth)acrylic monomer unit, and the polyfunctional monomer unit is at least one member selected from the group consisting of a polyfunctional styrenic monomer unit and a polyfunctional (meth)acrylic monomer unit.

8. The vinyl-based resin particles according to claim 1, wherein a pH of 3 to 9 is obtained when the vinyl-based resin particles are dispersed in water so that the mass ratio of the vinyl-based resin particles to water is 1:10.

9. A method for producing the vinyl-based resin particles according to claim 5, the method comprising:
an emulsion polymerization step of emulsion-polymerizing a first polymerizable vinylic monomer in an aqueous medium to obtain an aqueous dispersion containing polymer particles of the first polymerizable vinylic monomer and the aqueous medium;
a pH adjustment step of adding a nitrogen-containing compound to the aqueous dispersion obtained in the emulsion polymerization step to adjust the pH of the aqueous dispersion to 3 to 9;
a spray-drying step of spray-drying the aqueous dispersion obtained in the pH adjustment step at an inlet temperature of 80 to 220° C. and an outlet temperature of 50 to 100° C. to obtain an aggregate; and
a crushing step of crushing the aggregate obtained in the spray-drying step to obtain vinyl-based resin particles.

10. The method for producing the vinyl-based resin particles according to claim 9, comprising at least one of a first classification step of classifying the polymer particles obtained in the emulsion polymerization step and a second classification step of classifying the vinyl-based resin particles obtained in the crushing step.

11. A method for producing the vinyl-based resin particles according to claim 6, the method comprising:
a seed polymerization step of performing seed polymerization by absorbing a second polymerizable vinylic monomer into seed particles to obtain an aqueous dispersion containing polymer particles of the second polymerizable vinylic monomer and an aqueous medium;
a spray-drying step of spray-drying the aqueous dispersion obtained in the seed polymerization step at an inlet temperature of 80 to 220° C. and an outlet temperature of 50 to 100° C. to obtain an aggregate; and
a crushing step of crushing the aggregate obtained in the spray-drying step to obtain vinyl-based resin particles,
wherein in the seed polymerization step, the second polymerizable vinylic monomer comprise a monofunctional monomer and a polyfunctional monomer, and the second polymerizable vinylic monomer comprise the polyfunctional monomer in an amount of 1 to 15 parts by mass based on 100 parts by mass of the monofunctional monomer.

12. The method for producing the vinyl-based resin particles according to claim 11, comprising at least one of a first classification step of classifying the polymer particles obtained in the seed polymerization step and a second classification step of classifying the vinyl-based resin particles obtained in the crushing step.
